(19) United States
(12) Patent Application Publication
(10) Pub. No.: US 2004/0165790 A1
(43) Pub. Date: Aug. 26, 2004

(54) Image data processing apparatus

(76) Inventor: Sadafumi Kanada, Moriya-shi (JP)

Correspondence Address: LOUIS WOO, LAW OFFICE OF LOUIS WOO, 717 NORTH FAYETTE STREET, ALEXANDRIA, VA, 22314, US

(21) Appl. No.: 10/761,219

(22) Filed: Jan. 22, 2004

(30) Foreign Application Priority Data
Feb. 20, 2003 (JP) 2003-042044
Nov. 21, 2003 (JP) 2003-392899

(51) Int. Cl. G06K 9/32

(52) U.S. Cl. 382/300

(57) ABSTRACT

An image data processing apparatus includes a first device for monitoring a level of a first digital signal representative of an original picture in a prescribed region having a predetermined number of pixels, and deciding whether or not the monitored level changes discontinuously at a pixel of interest in the prescribed region. First data representative of a linear interpolation coefficient are generated in response to a conversion magnification. Second data representative of a non-linear-interpolation coefficient are generated in response to the conversion magnification. The first data are selected when the monitored level does not change discontinuously at the pixel of interest. The second data are selected when the monitored level changes discontinuously at the pixel of interest. The first digital signal is subjected to an interpolation-based filtering process responsive to the selected data to generate a second digital signal representative of a conversion-result picture.

### BACKGROUND OF THE INVENTION

1. Field of the Invention

This invention relates to an apparatus for processing and converting first image data into second image data in accordance with a designated magnification. A frame represented by the first image data is composed of a first predetermined number of pixels while a frame represented by the second image data is composed of a second predetermined number of pixels which differs from the first predetermined number. Therefore, the conversion of the first image data into the second image data involves a change in the resolution of a represented 1-frame picture.

2. Description of the Related Art

In the case where the number of pixels composing one frame represented by first image data differs from the number of pixel-corresponding segments constituting the screen of a display, the first image data are required to be converted into second image data representing a frame composed of a number of pixels which is equal to the number of pixel-corresponding segments of the display screen. The conversion of the first image data into the second image data involves conversion of the resolution of a represented 1-frame picture. It is known to utilize linear interpolation for such picture resolution conversion.

Known image data processing apparatuses utilizing linear interpolation procedures for picture resolution conversion tend to cause an insufficient quality of a conversion-result picture when an original picture is in a particular condition.

### SUMMARY OF THE INVENTION

It is an object of this invention to provide an improved image data processing apparatus.

A first aspect of this invention provides an image data processing apparatus comprising first means for monitoring a level of a first digital signal representative of an original picture in a prescribed region having a predetermined number of pixels, and deciding whether or not the monitored level changes discontinuously at a pixel of interest in the prescribed region; second means for generating first data representative of a linear interpolation coefficient in response to a conversion magnification; third means for generating second data representative of a non-linear-interpolation coefficient in response to the conversion magnification; fourth means for selecting the first data generated by the second means as selection-result data when the first means decides that the monitored level does not change discontinuously at the pixel of interest, and selecting the second data generated by the third means as the selection-result data when the first means decides that the monitored level changes discontinuously at the pixel of interest; and fifth means for subjecting the first digital signal to an interpolation-based filtering process responsive to the selection-result data generated by the fourth means to convert the first digital signal into a second digital signal representative of a conversion-result picture.

A second aspect of this invention is based on the first aspect thereof, and provides an image data processing apparatus wherein the third means and the fourth means comprise means for using the level of the first digital signal at the pixel of interest as a level of the second digital signal at a pixel in a setting range containing a time point corresponding to the pixel of interest when the first means decides that the monitored level changes discontinuously at the pixel of interest, and means for increasing the setting range as the conversion magnification decreases.

A third aspect of this invention is based on the first aspect thereof, and provides an image data processing apparatus wherein the third means and the fourth means comprise means for using the level of the first digital signal at the pixel of interest as a level of the second digital signal at a pixel in a setting range containing a time point corresponding to the pixel of interest when the first means decides that the monitored level changes discontinuously at the pixel of interest, and means for increasing the setting range as the conversion magnification increases in cases where the conversion magnification corresponds to picture enlarging conversion.

A fourth aspect of this invention provides an image data processing apparatus comprising first means for detecting luminance levels represented by a predetermined number of pieces of a first digital signal representative of an original picture, the pieces of the first digital signal indicating periodically-updated neighboring pixels including a periodically-updated pixel of interest in the original picture; second means for calculating differences among the luminance levels detected by the first means; third means for deciding whether or not an absolute value of each of the differences calculated by the second means exceeds a predetermined threshold value; fourth means for determining whether or not the pixel of interest corresponds to an isolated point in the original picture in response to a result of the deciding by the third means; fifth means for setting a luminance level represented by a piece in question of a second digital signal representative of a conversion-result picture in accordance with the luminance level represented by the piece of the first digital signal which indicates the pixel of interest without interpolation when the fourth means determines that the pixel of interest corresponds to an isolated point in the original picture, the piece in question of the second digital signal indicating a pixel in the conversion-result picture which corresponds to the pixel of interest in the original picture; and sixth means for setting the luminance level represented by the piece in question of the second digital signal according to interpolation responsive to luminance levels represented by neighboring pieces of the first digital signal when the fourth means determines that the pixel of interest does not corresponds to an isolated point in the original picture.

### BRIEF DESCRIPTION OF THE DRAWINGS

FIG. 1 is a time-domain diagram of prior-art picture reducing conversion of a sequence of original pixel-corresponding data pieces into a sequence of conversion-result pixel-corresponding data pieces.

FIG. 2 is a time-domain diagram of a sequence of original pixel-corresponding data pieces and sequences of conversion-result pixel-corresponding data pieces generated by a prior-art image data processing apparatus.

FIG. 3 is a time-domain diagram of an example of a waveform represented by a sequence of original pixel-corresponding data pieces and waveforms represented by sequences of conversion-result pixel-corresponding data pieces generated in a prior-art image data processing apparatus.

FIG. 4 is a block diagram of an image data processing apparatus according to an embodiment of this invention.

FIG. 5 is a time-domain diagram of a first example of a change in level represented by an input digital signal, and a change in state of a property signal in the apparatus of FIG. 4.

FIG. 6 is a time-domain diagram of a second example of a change in level represented by the input digital signal, and a change in state of the property signal in the apparatus of FIG. 4.

FIG. 7 is a block diagram of a resolution conversion circuit in FIG. 4.

FIG. 8 is a time-domain diagram of an example of a waveform represented by a sequence of original pixel-corresponding data pieces and a waveform represented by a sequence of conversion-result pixel-corresponding data pieces generated by the apparatus of FIG. 4.

FIG. 9 is a time-domain diagram of picture reducing conversion of a sequence of original pixel-corresponding data pieces into a sequence of conversion-result pixel-corresponding data pieces, waveforms represented by sequences of conversion-result pixel-corresponding data pieces, a waveform of a property signal, and a state of a coefficient combination.

FIG. 10 is a time-domain diagram of picture enlarging conversion of a sequence of original pixel-corresponding data pieces into a sequence of conversion-result pixel-corresponding data pieces, waveforms represented by sequences of conversion-result pixel-corresponding data pieces, a waveform of a property signal, and a state of a coefficient combination.

FIG. 11 is a time-domain diagram of a sequence of original pixel-corresponding data pieces and sequences of conversion-result pixel-corresponding data pieces generated by picture reducing conversion with a magnification factor of 4/5 and at different interpolation phases.

FIG. 12 is a time-domain diagram of a sequence of original pixel-corresponding data pieces and sequences of conversion-result pixel-corresponding data pieces generated by picture reducing conversion with a magnification factor of 4/6 and at different interpolation phases.

FIG. 13 is a time-domain diagram of a sequence of original pixel-corresponding data pieces and sequences of conversion-result pixel-corresponding data pieces generated by picture reducing conversion with a magnification factor of 4/7 and at different interpolation phases.

FIG. 14 is a time-domain diagram of a sequence of original pixel-corresponding data pieces and sequences of conversion-result pixel-corresponding data pieces generated by picture enlarging conversion with a magnification factor of 5/4 and at different interpolation phases.

FIG. 15 is a time-domain diagram of a sequence of original pixel-corresponding data pieces and sequences of conversion-result pixel-corresponding data pieces generated by picture enlarging conversion with a magnification factor of 6/4 and at different interpolation phases.

FIG. 16 is a time-domain diagram of a sequence of original pixel-corresponding data pieces and sequences of conversion-result pixel-corresponding data pieces generated by picture enlarging conversion with a magnification factor of 7/4 and at different interpolation phases.

### DETAILED DESCRIPTION OF THE INVENTION

Prior-art image data processing apparatuses will be explained below for a better understanding of this invention.

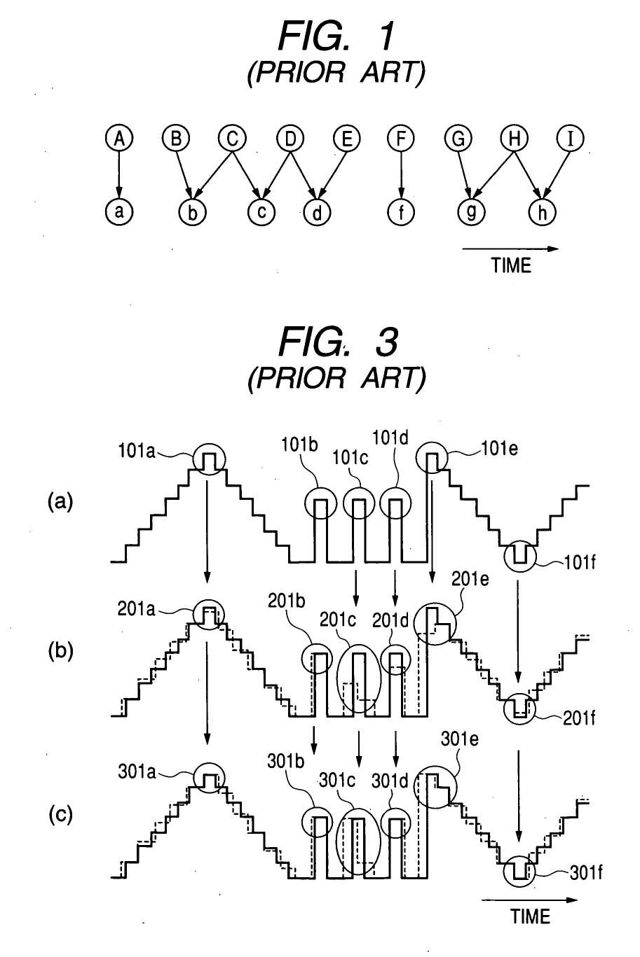

With reference to FIG. 1, a first prior-art apparatus utilizes linear interpolation to convert a sequence of pixel-corresponding data pieces A-I into a sequence of pixel-corresponding data pieces “a”-“d” and “f”-“h”. This conversion corresponds to a pixel-number reduction or a picture reduction with a magnification factor of 4/5. During the conversion, the signal level (the luminance level) represented by the original data piece A is directly used as that represented by the conversion-result data piece “a”. The signal level of the original data piece B is multiplied by 0.75 to get a multiplication result 0.75B while the signal level of the original data piece C is multiplied by 0.25 to get a multiplication result 0.25C. The sum of the multiplication results 0.75B and 0.25C is used as the signal level of the conversion-result data piece “b”. The signal level of the original data piece C is multiplied by 0.5 to get a multiplication result 0.5C while the signal level of the original data piece D is multiplied by 0.5 to get a multiplication result 0.5D. The sum of the multiplication results 0.5C and 0.5D is used as the signal level of the conversion-result data piece “c”.

In the case where original image data fed to the first prior-art apparatus represent a picture containing white isolated points such as white dots or stripes on a black background, the quality of a picture represented by conversion-result image data generated by the first prior-art apparatus is relatively low since the luminance at each of the isolated points is decreased relative to the original level.

A second prior-art apparatus utilizes nearest-neighbor interpolation to convert a sequence of pixel-corresponding data pieces A-G into a sequence of pixel-corresponding data pieces “a”-“d”. This conversion corresponds to a pixel-number reduction or a picture reduction with a magnification factor of 4/7. The second prior-art apparatus takes an interpolation phase which can be selected from different predetermined interpolation phases.

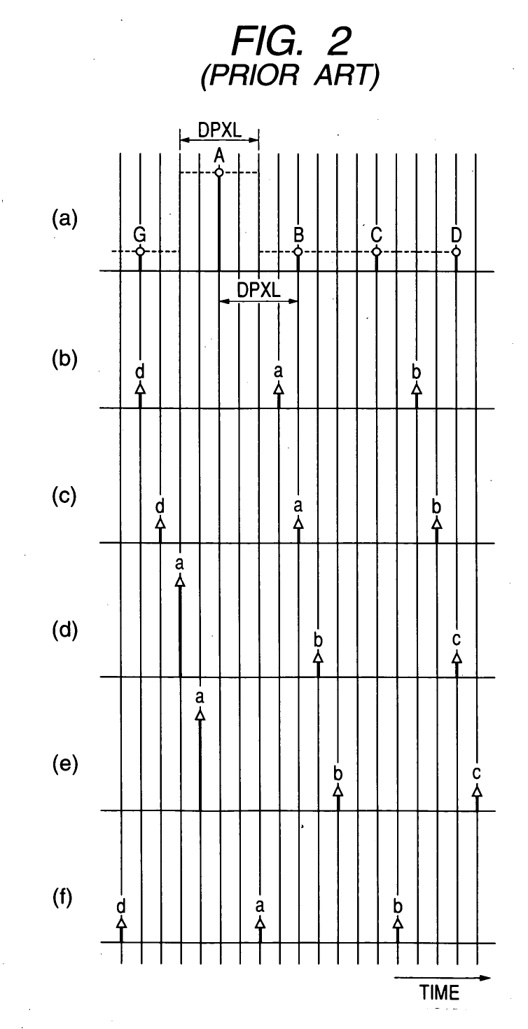

FIG. 2 has a portion (a) showing an example of the pixel positions corresponding to the original data pieces A-G, and the signal levels represented by the original data pieces A-G. In the portion (a) of FIG. 2, the original data pieces G, B, C, and D represent a low-luminance background on which a high-luminance isolated point corresponding to the original data piece A is located. Portions (b), (c), (d), (e), and (f) of FIG. 2 show the conversion-result data pieces “a”-“d” generated by the second prior-art apparatus, and correspond to the different interpolation phases respectively.

With reference to the portions (a) and (b) of FIG. 2, the second prior-art apparatus uses the signal level of the original data piece G as the signal level of the conversion-result data piece “d”. The second prior-art apparatus uses the signal levels of the original data pieces B and D as the signal levels of the conversion-result data pieces “a” and “b”, respectively. The pixel corresponding to the conversion-result data piece “b” exists at the boundary between the adjacent regions around the pixels corresponding to the original data pieces C and D. The pixel corresponding to the conversion-result data piece “b” is assigned the signal level of the right-hand original pixel, that is, the pixel corresponding to the original data piece D.

With reference to the portions (a) and (c) of FIG. 2, the second prior-art apparatus uses the signal level of the original data piece G as the signal level of the conversion-result data piece “d”. The second prior-art apparatus uses the signal levels of the original data pieces B and D as the signal levels of the conversion-result data pieces “a” and “b”, respectively.

With reference to the portions (a) and (d) of FIG. 2, the second prior-art apparatus uses the signal level of the original data piece A as the signal level of the conversion-result data piece “a”. The second prior-art apparatus uses the signal levels of the original data pieces B and D as the signal levels of the conversion-result data pieces “b” and “c”, respectively.

With reference to the portions (a) and (e) of FIG. 2, the second prior-art apparatus uses the signal level of the original data piece A as the signal level of the conversion-result data piece “a”. The second prior-art apparatus uses the signal levels of the original data pieces C and D as the signal levels of the conversion-result data pieces “b” and “c”, respectively.

With reference to the portions (a) and (f) of FIG. 2, the second prior-art apparatus uses the signal level of the original data piece G as the signal level of the conversion-result data piece “d”. The second prior-art apparatus uses the signal levels of the original data pieces B and C as the signal levels of the conversion-result data pieces “a” and “b”, respectively.

As shown in the portion (a) of FIG. 2, a time interval between neighboring pixels in an original picture is denoted by DPXL. A reference time region equal in length to the inter-pixel interval DPXL is centered at the time position of every pixel in an original picture. Basically, in the second prior-art apparatus which utilizes the nearest-neighbor interpolation, a conversion-result pixel at a time position corresponding to within a reference time region is assigned the luminance level of an original pixel in the reference time region.

As understood from the portions (b), (c), and (f) of FIG. 2, the interpolation phases taken by the second prior-art apparatuses cause the high-luminance isolated point represented by the original data piece A to be omitted from the conversion-result pictures. Accordingly, picture reducing conversion utilizing the nearest-neighbor interpolation omits white dots or stripes on a black background in an original picture from a conversion-result picture when the interpolation phase is equal to a certain value.

Japanese patent application publication number P2001-274987A discloses an image processing apparatus including a resolution conversion circuit which utilizes linear interpolation to convert a sequence of original pixel-corresponding data pieces into a sequence of interpolation-result pixel-corresponding data pieces at a picture reduction factor of 4/5. The apparatus of Japanese application P2001-274987A further includes a waveform monitor circuit and a data correction circuit. The waveform monitor circuit observes a predetermined number of successive original pixel-corresponding data pieces, which are periodically updated, to detect every local signal-level maximum and every local signal-level minimum represented by the sequence of the original pixel-corresponding data pieces. The waveform monitor circuit informs the data correction circuit of the detected local signal-level maximums and minimums. The data correction circuit receives the sequence of interpolation-result pixel-corresponding data pieces from the resolution conversion circuit. When an interpolation-result pixel-corresponding data piece of interest corresponds to a detected local signal-level maximum or minimum, the data correction circuit outputs a conversion-result pixel-corresponding data piece assigned the detected local signal-level maximum or minimum. Otherwise, the data correction circuit passes the interpolation-result pixel-corresponding data piece of interest as a conversion-result pixel-corresponding data piece.

FIG. 3 has a portion (a) showing an example of the waveform composed of signal levels represented by successive original pixel-corresponding data pieces. The waveform in the portion (a) of FIG. 3 has local signal-level maximums 101a, 101b, 101c, 101d, and 101e, and a local signal-level minimum 101f. The resolution conversion circuit in the apparatus of Japanese application P2001-274987A changes the original pixel-corresponding data pieces representative of the waveform in the portion (a) of FIG. 3 into interpolation-result pixel corresponding data pieces representing a waveform expressed by the broken lines in a portion (b) of FIG. 3. The broken-line waveform in the portion (b) of FIG. 3 has local signal-level maximums 201a, 201b, 201c, 201d, and 201e, and a local signal-level minimum 201f corresponding to the local signal-level maximums 101a, 101b, 101c, 101d, and 101e, and the local signal-level minimum 101f in the portion (a) of FIG. 3. The local signal-level maximums 201c, 201d, and 201e considerably deviate from the corresponding local signal-level maximums 101c, 101d, and 101e. The broken lines in a portion (c) of FIG. 3 express the waveform represented by a sequence of conversion-result pixel-corresponding data pieces which are responsive to the original pixel-corresponding data pieces representative of the waveform in the portion (a) of FIG. 3, and which are outputted from the data correction circuit in the apparatus of Japanese application P2001-274987A. The broken-line waveform in the portion (c) of FIG. 3 has local signal-level maximums 301a, 301b, 301c, 301d, and 301e, and a local signal-level minimum 301f corresponding to the local signal-level maximums 101a, 101b, 101c, 101d and 101e, and the local signal-level minimum 101f in the portion (a) of FIG. 3. While the local signal-level maximums 301d and 301e are improved over the local signal-level maximums 201d and 201e, the rear-edge (the trailing edge) of the local signal-level maximum 301c is still considerably different from that of the corresponding local signal-level maximum 101c.

Japanese application P2001-274987A discloses that the resolution conversion circuit of the picture reduction type may be replaced by a resolution conversion circuit of a picture enlargement type when an original picture is requested to be enlarged.

A test has been made as to operation of an apparatus which is similar to the apparatus in Japanese application P2001-274987A except that a linear-interpolation-based resolution conversion circuit is of an enlargement type. The results of the test show the occurrence of problems as follows. When an isolated point exists at a certain position relative to an original picture, the isolated point is converted into a short line in a conversion-result picture represented by conversion-result data pieces generated by the apparatus. Under a certain condition, a thin line in the original picture is converted into a thick line in the conversion-result picture.

### Embodiment

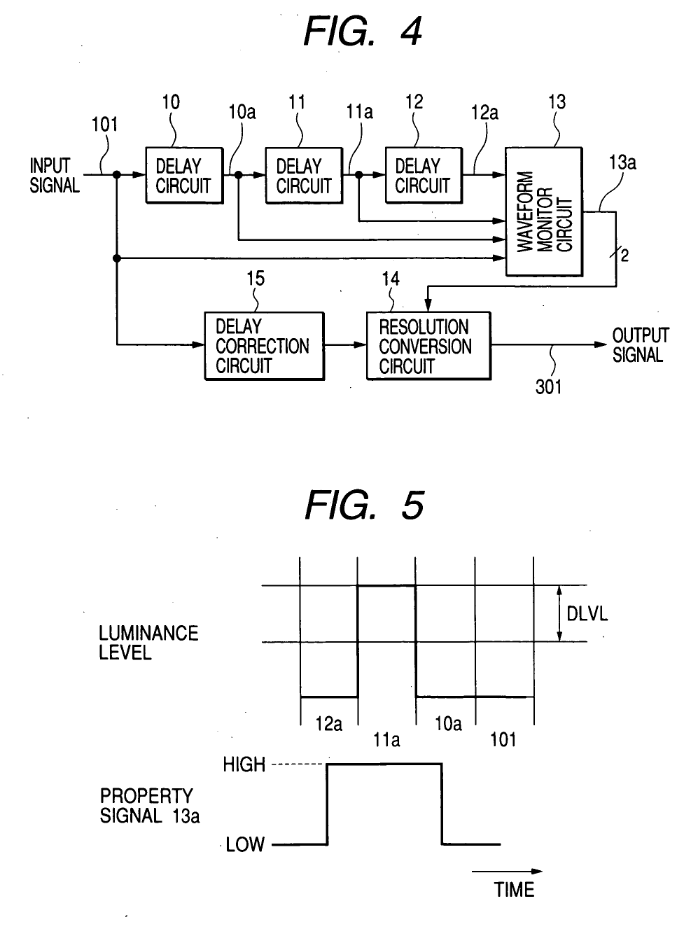

FIG. 4 shows an image data processing apparatus according to an embodiment of this invention. The apparatus of FIG. 4 includes delay circuits 10, 11, and 12, a waveform monitor circuit 13, a resolution conversion circuit 14, and a delay correction circuit 15.

An input digital signal 101 representing an original picture is fed to the input sides of the delay circuit 10 and the delay correction circuit 15. The input digital signal 101 is also fed to a first input terminal of the waveform monitor circuit 13. The output side of the delay circuit 10 is connected to the input side of the delay circuit 11 and a second input terminal of the waveform monitor circuit 13. The output side of the delay circuit 11 is connected to the input side of the delay circuit 12 and a third input terminal of the waveform monitor circuit 13. The output side of the delay circuit 12 is connected to a fourth input terminal of the waveform monitor circuit 13. The output terminal of the waveform monitor circuit 13 is connected to a first input terminal of the resolution conversion circuit 14. The output terminal of the delay correction circuit 15 is connected to a second input terminal of the resolution conversion circuit 14. The resolution conversion circuit 14 outputs a digital signal 301 representing a conversion-result picture.

For example, the input digital signal 101 is of a line-by-line scanning format, and has a sequence of pixel-corresponding pieces. The apparatus of FIG. 4 operates in either a horizontal-direction mode or a vertical-direction mode. During the horizontal-direction mode of operation, each of the delay circuits 10, 11, and 12 provides a signal delay corresponding to one pixel. During the vertical-direction mode of operation, each of the delay circuits 10, 11, and 12 provides a signal delay corresponding to one line.

The delay circuit 10 defers the input digital signal 101 by a time corresponding to one pixel or one line to get a first delayed signal 10a. The delay circuit 10 feeds the first delayed signal 10a to the delay circuit 11 and the waveform monitor circuit 13. The delay circuit 11 defers the first delayed signal 10a by a time corresponding to one pixel or one line to get a second delayed signal 11a. The delay circuit 11 feeds the second delayed signal 11a to the delay circuit 12 and the waveform monitor circuit 13. The delay circuit 12 defers the second delayed signal 11a by a time corresponding to one pixel or one line to get a third delayed signal 12a. The delay circuit 12 feeds the third delayed signal 12a to the waveform monitor circuit 13. The input digital signal 101, the first delayed signal 10a, the second delayed signal 11a, and the third delayed signal 12a fed to the waveform monitor circuit 13 represent four pixels which neighbor in a horizontal direction or a vertical direction with respect to a frame.

The waveform monitor circuit 13 observes luminance levels or signal levels at pixel positions in a periodically-updated frame portion (a periodically-updated frame region) covered by four neighboring pixels. Specifically, the waveform monitor circuit 13 detects the levels (the luminance levels) represented by the signals 101, 10a, 11a, and 12a, that is, the signal levels at four neighboring pixels in the periodically-updated monitored frame region.

The waveform monitor circuit 13 computes the difference between the detected levels represented by the input digital signal 101 and the first delayed signal 10a. This difference is referred to as the first difference. The waveform monitor circuit 13 calculates the absolute value of the first difference. The waveform monitor circuit 13 computes the difference between the detected levels represented by the first delayed signal 10a and the second delayed signal 11a. This difference is referred to as the second difference. The waveform monitor circuit 13 calculates the absolute value of the second difference. The waveform monitor circuit 13 computes the difference between the detected levels represented by the second delayed signal 11a and the third delayed signal 12a. This difference is referred to as the third difference. The waveform monitor circuit 13 calculates the absolute value of the third difference.

The waveform monitor circuit 13 compares the calculated absolute value of the first difference with a predetermined threshold value DLVL, and thereby decides whether or not the calculated absolute value of the first difference exceeds the predetermined threshold value DLVL. The waveform monitor circuit 13 generates a first decision signal representing the result of the decision about the calculated absolute value of the first difference. The waveform monitor circuit 13 compares the calculated absolute value of the second difference with the predetermined threshold value DLVL, and thereby decides whether or not the calculated absolute value of the second difference exceeds the predetermined threshold value DLVL. The waveform monitor circuit 13 generates a second decision signal representing the result of the decision about the calculated absolute value of the second difference. The waveform monitor circuit 13 compares the calculated absolute value of the third difference with the predetermined threshold value DLVL, and thereby decides whether or not the calculated absolute value of the third difference exceeds the predetermined threshold value DLVL. The waveform monitor circuit 13 generates a third decision signal representing the result of the decision about the calculated absolute value of the third difference.

In the case where the first, second, and third decision signals indicate that the absolute values of the second and third differences exceed the predetermined threshold value DLVL while the absolute value of the first difference does not exceed the predetermined threshold value DLVL, the waveform monitor circuit 13 concludes that the level represented by the input digital signal 101 is discontinuously changing at a pixel position in the observed frame region which corresponds to the second delayed signal 11a, and that the pixel represented by the second delayed signal 11a corresponds to an isolated point in the original picture. In this case, for the pixel corresponding to the second delayed signal 11a, the waveform monitor circuit 13 generates a property signal 13a in a high-level state and outputs the high-level property signal 13a to the resolution conversion circuit 14. This case occurs when the levels (the luminance levels) represented by the signals 101, 10a, 11a, and 12a are equal to those in FIG. 5, that is, when four neighboring pixel-corresponding pieces of the input digital signal 101 represent a waveform shown in FIG. 5. In this case, the property signal 13a generated by the waveform monitor circuit 13 takes a high-level state for the pixel corresponding to the second delayed signal 11a as shown in FIG. 5. The time interval during which the property signal 13a remains in its high-level state is centered at a time point corresponding to the pixel represented by the second delayed signal 11a, and is equal in length to a 2-pixel term.

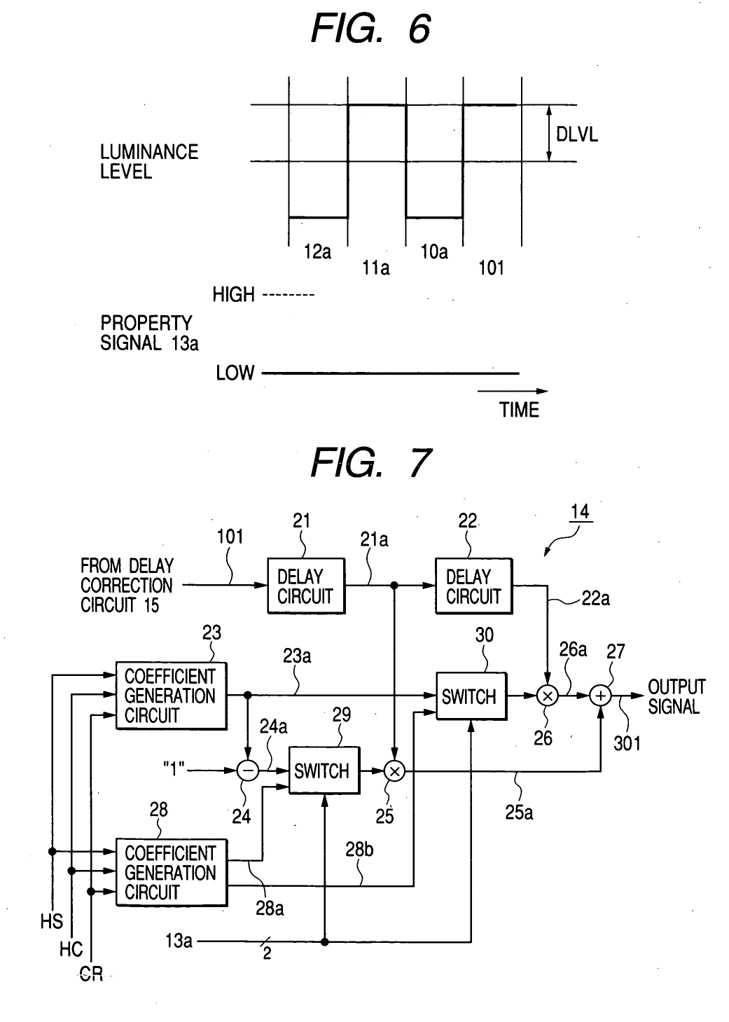

In other cases, the waveform monitor circuit 13 generates a property signal 13a in a low-level state and outputs the low-level property signal 13a to the resolution conversion circuit 14. For example, in the case where the first, second, and third decision signals indicate that the absolute values of the first, second, and third differences exceed the predetermined threshold value DLVL, the waveform monitor circuit 13 concludes that the pixel represented by the second delayed signal 11a does not correspond to an isolated point in the original picture. In this case, for the pixel corresponding to the second delayed signal 11a, the waveform monitor circuit 13 generates a property signal 13a in a low-level state and outputs the low-level property signal 13a to the resolution conversion circuit 14. This case occurs when the levels (the luminance levels) represented by the signals 101, 10a, 11a, and 12a are equal to those in FIG. 6, that is, when four neighboring pixel-corresponding pieces of the input digital signal 101 represent a waveform shown in FIG. 6. In this case, the property signal 13a generated by the waveform monitor circuit 13 takes a low-level state for the pixel corresponding to the second delayed signal 11a as shown in FIG. 6.

In this way, the waveform monitor circuit 13 observes the level represented by the input digital signal 101 in a prescribed time region having four neighboring pixel-corresponding pieces of the input digital signal 101 which are periodically updated. By referring to the observed level in the prescribed time region, the waveform monitor circuit 13 decides whether or not the observed level changes discontinuously at a pixel of interest in the prescribed time region, and whether or not the pixel of interest in the prescribed time region corresponds to an isolated point in the original picture.

The waveform monitor circuit 13 uses, for example, a microcomputer or a similar device programmed to implement the previously-mentioned operation steps.

The delay correction circuit 15 defers the input digital signal 101, and outputs the resultant digital signal to the resolution conversion circuit 14. Thus, the input digital signal 101 is propagated to the resolution conversion circuit 14 while being deferred by the delay correction circuit 15. The delay correction circuit 15 is designed to match the pixel-related timing of the application of the input digital signal 101 to the resolution conversion circuit 14 with the pixel-related timing of the application of the property signal 13a to the resolution conversion circuit 14 from the waveform monitor circuit 13.

The resolution conversion circuit 14 subjects the output digital signal from the delay correction circuit 15 to an interpolation-based filtering process responsive to a designated magnification, and thereby generates a conversion-result digital signal 301 representing a conversion-result picture. The resolution conversion circuit 14 outputs the conversion-result digital signal 301.

As shown in FIG. 7, the resolution conversion circuit 14 includes delay circuits 21 and 22, a coefficient generation circuit 23, a subtracter 24, multipliers 25 and 26, an adder 27, a coefficient generation circuit 28, and switches 29 and 30.

The input side of the delay circuit 21 is exposed to the output digital signal from the delay correction circuit 15. The output side of the delay circuit 21 is connected to the input side of the delay circuit 22 and a first input terminal of the multiplier 25. The output side of the delay circuit 22 is connected to a first input terminal of the multiplier 26. The coefficient generation circuits 23 and 28 receive a horizontal sync signal HS, a horizontal clock signal HC, and a parameter signal CR representing the designated magnification. The parameter signal CR is generated by, for example, an operation unit which can be actuated by a user. The designated magnification can be decided in accordance with user's request inputted via the operation unit. The output terminal of the coefficient generation circuit 23 is connected to a first input terminal of the subtracter 24 and a first input terminal of the switch 30. A second input terminal of the subtracter 24 is exposed to a fixed signal representing a coefficient of “1” which is produced by a signal generator (not shown). The output terminal of the subtracter 24 is connected to a first input terminal of the switch 29. The coefficient generation circuit 28 has first and second output terminals. The first output terminal of the coefficient generation circuit 28 is connected to a second input terminal of the switch 29. The second output terminal of the coefficient generation circuit 28 is connected to a second input terminal of the switch 30. The output terminal of the switch 29 is connected to a second input terminal of the multiplier 25. The output terminal of the multiplier 25 is connected to a first input terminal of the adder 27. The output terminal of the switch 30 is connected to a second input terminal of the multiplier 26. The output terminal of the multiplier 26 is connected to a second input terminal of the adder 27. The adder 27 outputs the conversion-result digital signal 301. The switches 29 and 30 have respective control terminals exposed to the property signal 13a fed from the waveform monitor circuit 13.

During the horizontal-direction mode of operation of the apparatus in FIG. 4, each of the delay circuits 21 and 22 provides a signal delay corresponding to one pixel. During the vertical-direction mode of operation, each of the delay circuits 21 and 22 provides a signal delay corresponding to one line.

The delay circuit 21 defers the output digital signal from the delay correction circuit 15 by a time corresponding to one pixel or one line to get a first delayed digital signal 21a. The delay circuit 21 feeds the first delayed digital signal 21a to the delay circuit 22 and the multiplier 25. The delay circuit 22 defers the first delayed digital signal 21a by a time corresponding to one pixel or one line to get a second delayed digital signal 22a. The delay circuit 22 feeds the second delayed digital signal 22a to the multiplier 26. The first delayed signal 21a and the second delayed signal 22a represent two periodically-updated pixels which neighbor each other as viewed in a horizontal direction or a vertical direction with respect to a frame.

The coefficient generation circuit 23 produces a signal 23a representative of a variable interpolation coefficient for a periodically-updated pixel of interest in response to the designated magnification indicated by the parameter signal CR. The coefficient generation circuit 23 feeds the interpolation coefficient signal 23a to the subtracter 24 and the switch 30 at a timing synchronized with the horizontal clock signal HC. Operation of the coefficient generation circuit 23 responds to the horizontal sync signal HS. The device 24 subtracts the interpolation coefficient represented by the signal 23a from a coefficient of “1”, and generates a signal 24a indicating an interpolation coefficient equal to the subtraction result. The subtracter 24 outputs the interpolation coefficient signal 24a to the switch 29 at a timing synchronized with the horizontal clock signal HC.

The coefficient generation circuit 28 produces signals 28a and 28b representing respective coefficients. The coefficient generation circuit 28 outputs the coefficient signals 28a and 28b to the switches 29 and 30 respectively at a timing synchronized with the horizontal clock signal HC. Operation of the coefficient generation circuit 28 responds to the horizontal sync signal HS. A combination of the coefficients represented by the output signals 28a and 28b from the coefficient generation circuit 28 can be changed between a first state and a second state. In the first state, the coefficients represented by the signals 28a and 28b are “1” and “0” respectively. In the second state, the coefficients represented by the signals 28a and 28b are “0” and “1” respectively. A timing of change from the first state to the second state, and a timing of change from the second state to the first state are varied in accordance with the designated magnification indicated by the parameter signal CR. Preferably, the change of a combination of the coefficients between the first and second states is accorded with a cyclic pattern depending on the designated magnification and synchronized with the horizontal clock signal HC.

The coefficient generation circuit 23 uses, for example, a microcomputer or a similar device programmed to generate and output the interpolation coefficient signal 23a in response to the horizontal clock signal HC, the horizontal sync signal HS, and the parameter signal CR. The coefficient generation circuit 28 uses, for example, a microcomputer or a similar device programmed to generate and output the coefficient signals 28a and 28b in response to the horizontal clock signal HC, the horizontal sync signal HS, and the parameter signal CR.

The switch 29 selects one from the interpolation coefficient signal 24a and the coefficient signal 28a in response to the property signal 13a. Specifically, the switch 29 selects the interpolation coefficient signal 24a when the property signal 13a is in its low-level state. The switch 29 selects the coefficient signal 28a when the property signal 13a is in its high-level state. The switch 29 passes the selected signal to the multiplier 25.

The switch 30 selects one from the interpolation coefficient signal 23a and the coefficient signal 28b in response to the property signal 13a. Specifically, the switch 30 selects the interpolation coefficient signal 23a when the property signal 13a is in its low-level state. The switch 30 selects the coefficient signal 28b when the property signal 13a is in its high-level state. The switch 30 passes the selected signal to the multiplier 26.

In the case where the property signal 13 is in its low-level state, the switches 29 and 30 transmit the interpolation coefficient signals 24a and 23a to the multipliers 25 and 26 respectively. The device 25 multiplies the level (the luminance level) represented by the first delayed digital signal 21a and the interpolation coefficient represented by the signal 24a to get an interpolation digital signal 25a. The multiplier 25 feeds the interpolation digital signal 25a to the adder 27. The device 26 multiplies the level (the luminance level) represented by the second delayed digital signal 22a and the interpolation coefficient represented by the signal 23a to get an interpolation digital signal 26a. The multiplier 26 feeds the interpolation digital signal 26a to the adder 27. The device 27 adds the levels represented by the interpolation digital signals 25a and 26a, and generates the conversion-result digital signal 301 in accordance with the result of the addition. Accordingly, in the case where the property signal 13 is in its low-level state, the resolution conversion circuit 14 subjects the output digital signal from the delay correction circuit 15 to a linear interpolation process or an interpolation-based filtering process to get the conversion-result digital signal 301.

Generally, the linear interpolation process generates a pixel represented by the conversion-result digital signal 301 from two neighboring pixels represented by the input digital signal 101. The conversion-result pixel is temporally located at a position between the time positions of the two original pixels. In other words, one of the original pixels precedes the conversion-result pixel while the other follows the conversion-result pixel.

In the case where the property signal 13 is in its high-level state, the switches 29 and 30 transmit the coefficient signals 28a and 28b to the multipliers 25 and 26 respectively. The device 25 multiplies the level represented by the first delayed digital signal 21a and the coefficient represented by the signal 28a to get a multiplication-result digital signal 25a. The multiplier 25 feeds the multiplication-result digital signal 25a to the adder 27. The device 26 multiplies the level represented by the second delayed digital signal 22a and the coefficient represented by the signal 28b to get a multiplication-result digital signal 26a. The multiplier 26 feeds the multiplication-result digital signal 26a to the adder 27. The device 27 adds the levels represented by the multiplication-result digital signals 25a and 26a, and generates the conversion-result digital signal 301 in accordance with the result of the addition. When a combination of the coefficients represented by the signals 28a and 28b is in the first state, the multiplication-result digital signal 25a is the same as the first delayed digital signal 21a and the multiplication-result digital signal 26a is “0”. Thus, the first delayed digital signal 21a is directly used as the conversion-result digital signal 301. In other words, a conversion-result pixel in question is assigned the signal level (the luminance level) corresponding to a pixel represented by the first delayed digital signal 21a, that is, an original pixel at a time position after the time position of the conversion-result pixel in question. When a combination of the coefficients represented by the signals 28a and 28b is in the second state, the multiplication-result digital signal 26a is the same as the second delayed digital signal 22a and the multiplication-result digital signal 25a is “0”. Thus, the second delayed digital signal 22a is directly used as the conversion-result digital signal 301. In other words, a conversion-result pixel in question is assigned the signal level corresponding to a pixel represented by the second delayed digital signal 22a, that is, an original pixel at a time position before the time position of the conversion-result pixel in question.

Operation of the apparatus in FIG. 4 can be changed among different modes including a mode corresponding to a pixel-number reduction or a picture reduction with a magnification factor of 4/5.

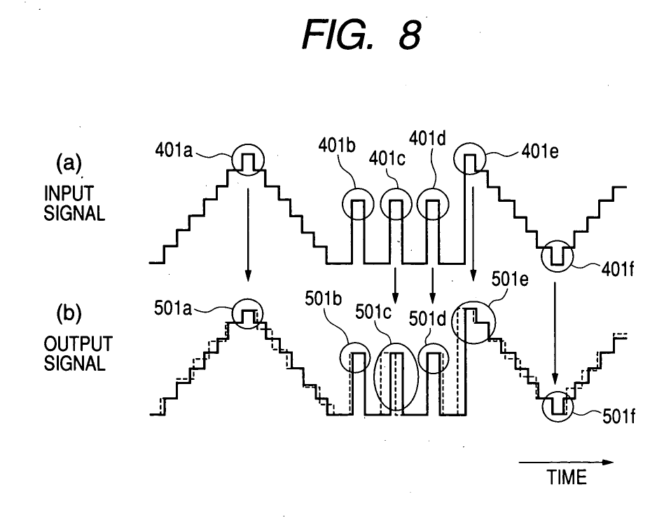

FIG. 8 has a portion (a) showing an example of the waveform composed of signal levels represented by successive pixel-corresponding pieces of the input digital signal 101. The waveform in the portion (a) of FIG. 8 has local signal-level maximums 401a, 401b, 401c, 401d, and 401e, and a local signal-level minimum 401f. Among them, the local signal-level maximums 401b, 401c, and 401d correspond to isolated points in an original picture. The apparatus of FIG. 4 which is operating in the 4/5 picture reduction mode changes the input digital signal 101 into the conversion-result digital signal (the output digital signal) 301 composed of successive pixel-corresponding pieces representing a waveform expressed by the broken lines in a portion (b) of FIG. 8. The broken-line waveform in the portion (b) of FIG. 8 has local signal-level maximums 501a, 501b, 501c, 501d, and 501e, and a local signal-level minimum 501f corresponding to the local signal-level maximums 401a, 401b, 401c, 401d, and 401e, and the local signal-level minimum 401f in the portion (a) of FIG. 8.

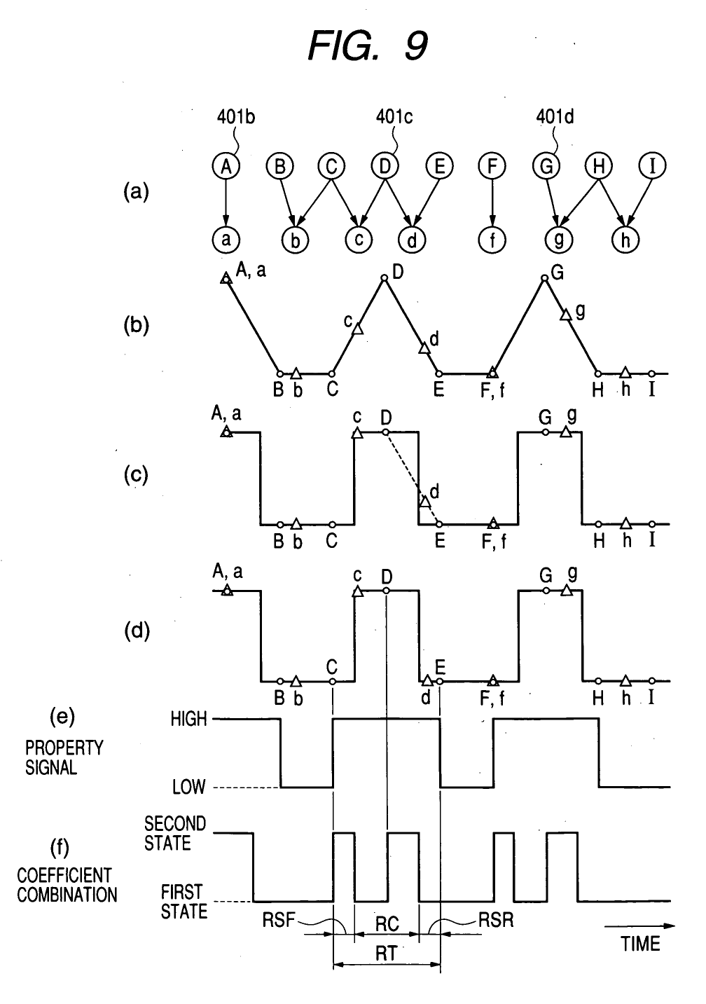

With reference to a portion (a) of FIG. 9, the apparatus of FIG. 4 which is operating in the 4/5 picture reduction mode converts a sequence of pixel-corresponding pieces A-I of the input digital signal 101 into a sequence of pixel-corresponding pieces “a”-“d” and “f”-“h” of the output digital signal (the conversion-result digital signal) 301. While the waveform monitor circuit 13 continues to conclude that the signal level represented by the input digital signal 101 is not discontinuously changing, the relation among the signal levels of the original data pieces A-I and the signal levels of the conversion-result data pieces “a”-“d” and “f”-“h” is as follows. During the conversion, the conversion-result data piece “a” is assigned the signal level (the luminance level) represented by the original data piece A. The signal level of the conversion-result data piece “b” is decided by linear interpolation responsive to the signal levels of the original data pieces B and C. The signal level of the conversion-result data piece “c” is decided by linear interpolation responsive to the signal levels of the original data pieces C and D. The signal level of the conversion-result data piece “d” is decided by linear interpolation responsive to the signal levels of the original data pieces D and E. The conversion-result data piece “f” is assigned the signal level represented by the original data piece F. The signal level of the conversion-result data piece “g” is decided by linear interpolation responsive to the signal levels of the original data pieces G and H. The signal level of the conversion-result data piece “h” is decided by linear interpolation responsive to the signal levels of the original data pieces H and I.

The original data pieces A, D, and G in the portion (a) of FIG. 9 are chosen to correspond to the local signal-level maximums 401b, 401c, and 401d in the portion (a) of FIG. 8, respectively.

In a portion (b) of FIG. 9, small circles denote an example of the signal levels of the original data pieces A-I among which the original data pieces A, D, and G correspond to the local signal-level maximums 401b, 401c, and 401d and the original data piece E represents a bottom signal level. Small triangles in the portion (b) of FIG. 9 denote the signal levels of the conversion-result data pieces “a”-“d” and “f”-“h” which are generated in the case where the resolution conversion circuit 14 is replaced with conventional one utilizing normal linear interpolation. In this case, the signal level of the conversion-result data piece “c” is equal to 0.5 times the signal level of the original data piece “D”. The signal level of the conversion-result data piece “d” is equal to 0.25 times the signal level of the original data piece “D”.

In a portion (c) of FIG. 9, small circles denote the example of the signal levels of the original data pieces A-I. Small triangles therein denote the signal levels of the conversion-result data pieces “a”-“d” and “f”-“h” which are generated by the prior-art apparatus in Japanese patent application publication number P2001-274987A. In this case, the conversion-result data pieces “a”, “c”, and “g” are assigned the signal levels of the original data pieces A, D, and G corresponding to the local signal-level maximums 401b, 401c, and 401d respectively. On the other hand, the conversion-result data piece “d” is assigned an interpolation-caused signal level intermediate between the signal levels of the original data pieces D and E. As a result, a pulse-like waveform represented by the conversion-resultant data pieces which corresponds to the local signal-level maximum (the isolated point) 401c has a blunt rear edge or a blunt trailing edge.

In a portion (d) of FIG. 9, small circles denote the example of the signal levels of the original data pieces A-I. Small triangles therein denote the signal levels of the conversion-result data pieces “a”-“d” and “f”-“h” which are generated by the apparatus of FIG. 4.

As shown in a portion (e) of FIG. 9, the state of the property signal 13a changes in response to the sequence of the original data pieces A-I. As shown in a portion (f) of FIG. 9, a combination of the coefficients represented by the output signals 28a and 28b from the coefficient generation circuit 28 cyclically changes between the first state and the second state in a pattern synchronized with the original data pieces A-I. As understood from the portions (a), (e), and (f) of FIG. 9, the property signal 13a is in its high-level state and a combination of the coefficients is in its first state for the conversion-result data piece “c”. Therefore, the signal level of the original data piece C is multiplied by “0” and the signal level of the original data piece D is directly used as the signal level of the conversion-result data piece “c”. Similarly, the property signal 13a is in its high-level state and a combination of the coefficients is in its first state for the conversion-result data piece “d”. Therefore, the signal level of the original data piece D is multiplied by “0” and the signal level of the original data piece E is directly used as the signal level of the conversion-result data piece “d”. The original data piece E represents the bottom signal level. Thus, as shown in the portion (d) of FIG. 9, a pulse-like waveform represented by the conversion-resultant data pieces which corresponds to the local signal-level maximum (the isolated point) 401c has a sharp rear edge or a sharp trailing edge.

With reference to the portions (d), (e), and (f) of FIG. 9, there is a time region RT of twice the inter-pixel interval during which the property signal 13a is in its high-level state so that linear interpolation is non-implemented. This time region RT is called the non-interpolation region RT. The non-interpolation region RT is centered at a time point corresponding to an original pixel (an original data piece) at which the waveform monitor circuit 13 concludes that the signal level represented by the input digital signal 101 is discontinuously changing. The non-interpolation region RT consists of a front edge region RSF, a central region RC, and a rear edge region RSR. The front edge region RSF precedes the central region RC. The rear edge region RSR follows the central region RC. The central region RC contains a time point corresponding to the original pixel at which the waveform monitor circuit 13 concludes that the signal level represented by the input digital signal 101 is discontinuously changing. When a time point corresponding to a conversion-result pixel (a conversion-result data piece) in question exists in the central region RC, the signal level of the original pixel at which the signal level represented by the input digital signal 101 is concluded to be discontinuously changing is used as the signal level of the conversion-result pixel in question. When a time point corresponding to a conversion-result pixel (a conversion-result data piece) in question exists in the front edge region RSF, the signal level of an original pixel at a time point in the front edge region RSF is used as the signal level of the conversion-result pixel in question. When a time point corresponding to a conversion-result pixel (a conversion-result data piece) in question exists in the rear edge region RSR, the signal level of an original pixel at a time point in the rear edge region RSR is used as the signal level of the conversion-result pixel in question.

It is preferable that the width of the central region RC depends on the designated magnification indicated by the parameter signal CR. This design prevents isolated points from being omitted from the conversion-result picture even when the designated magnification is changed.

As shown in FIG. 8, the pulse-like waveform portion 501c represented by the conversion-result digital signal (the output digital signal) 301 is closer in shape to the corresponding waveform portion 401c represented by the input digital signal 101.

The resolution conversion circuit 14 is of a picture reduction type. Alternatively, the resolution conversion circuit 14 may be of a picture enlargement type. In this case, the resolution conversion circuit 14 acts to enlarge an original picture or increase the number of pixels composing one frame. The resolution conversion circuit 14 of the picture enlargement type has a structure similar to that shown in FIG. 7.

The resolution conversion circuit 14 in FIG. 7 can be used as the picture reduction type and also the picture enlargement type on a selective basis.

Operation of the apparatus in FIG. 4 which includes the resolution conversion circuit 14 of the picture enlargement type can be changed among different modes including a mode corresponding to a pixel-number increase or a picture enlargement with a magnification factor of 5/4.

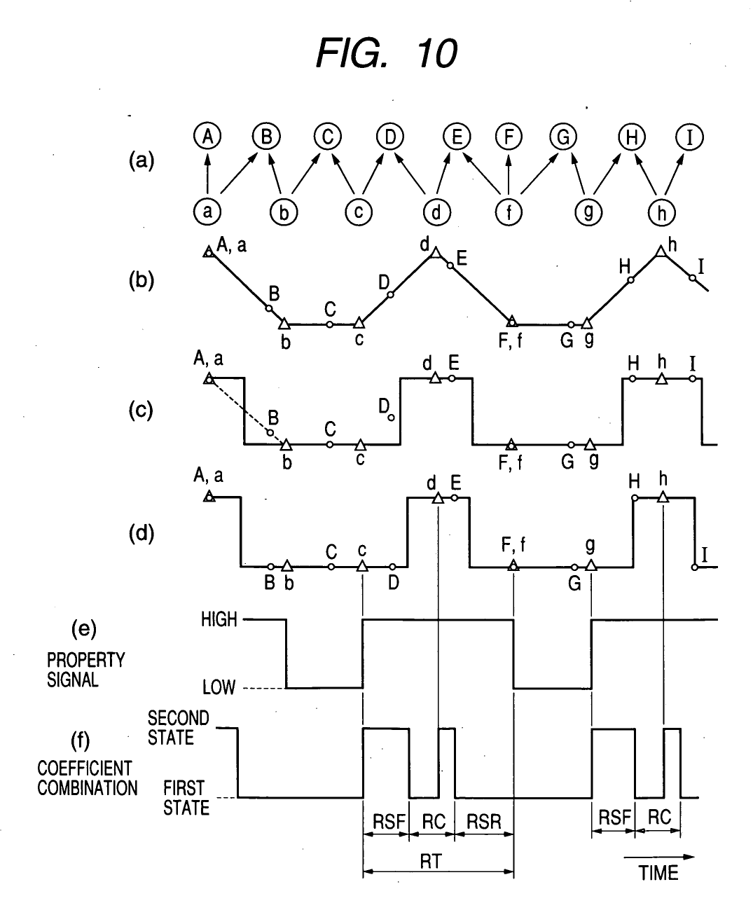

With reference to a portion (a) of FIG. 10, the apparatus of FIG. 4 which is operating in the 5/4 picture enlargement mode converts a sequence of pixel-corresponding pieces “a”-“d” and “f”-“h” of the input digital signal 101 into a sequence of pixel-corresponding pieces A-I of the output digital signal (the conversion-result digital signal) 301. While the waveform monitor circuit 13 continues to conclude that the signal level represented by the input digital signal 101 is not discontinuously changing, the relation among the signal levels of the original data pieces “a”-“d” and “f”-“h” and the signal levels of the conversion-result data pieces A-I is as follows. During the conversion, the conversion-result data piece A is assigned the signal level (the luminance level) represented by the original data piece “a”. The signal level of the conversion-result data piece B is decided by linear interpolation responsive to the signal levels of the original data pieces “a” and “b”. The signal level of the conversion-result data piece C is decided by linear interpolation responsive to the signal levels of the original data pieces “b” and “c”. The signal level of the conversion-result data piece D is decided by linear interpolation responsive to the signal levels of the original data pieces “c” and “d”. The conversion-result data piece E is decided by linear interpolation responsive to the signal levels of the original data pieces “d” and “f”. The conversion-result data piece F is assigned the signal level represented by the original data piece “f”. The signal level of the conversion-result data piece G is decided by linear interpolation responsive to the signal levels of the original data pieces “f” and “g”. The signal level of the conversion-result data piece H is decided by linear interpolation responsive to the signal levels of the original data pieces “g” and “h”.

In a portion (b) of FIG. 10, small triangles denote an example of the signal levels of the original data pieces “a”-“d” and “f”-“h” among which the original data pieces “d” and “h” correspond to local signal-level maximums (isolated points). Small circles in the portion (b) of FIG. 10 denote the signal levels of the conversion-result data pieces A-I which are generated in the case where the resolution conversion circuit 14 is replaced with conventional one utilizing normal linear interpolation.

In a portion (c) of FIG. 10, small triangles denote the example of the signal levels of the original data pieces “a”-“d” and “f”-“h”. Small circles therein denote the signal levels of the conversion-result data pieces A-I which are generated by the prior-art apparatus in Japanese patent application publication number P2001-274987A. In this case, the isolated point “h” in the original picture is changed into two successive high-level pixels represented by the conversion-result data pieces H and I. Thus, there occurs an irregularity in luminance concerning the isolated point.

In a portion (d) of FIG. 10, small triangles denote the example of the signal levels of the original data pieces “a”-“d” and “f”-“h”. Small circles therein denote the signal levels of the conversion-result data pieces A-I which are generated by the apparatus of FIG. 4.

As shown in a portion (e) of FIG. 10, the state of the property signal 13a changes in response to the sequence of the original data pieces “a”“d” and “f”-“h”. As shown in a portion (f) of FIG. 10, a combination of the coefficients represented by the output signals 28a and 28b from the coefficient generation circuit 28 cyclically changes between the first state and the second state in a pattern synchronized with the original data pieces “a”-“d” and “f”-“h”. As understood from the portions (a), (e), and (f) of FIG. 10, the property signal 13a is in its high-level state and a combination of the coefficients is in its first state for the conversion-result data piece B. Therefore, the signal level of the original data piece “a” is multiplied by “0” and the signal level of the original data piece “b” is directly used as the signal level of the conversion-result data piece B. Thus, the conversion-result pixel B is assigned the signal level of the original pixel “b” at a time position after the time position of the conversion-result pixel B. The property signal 13a is in its high-level state and a combination of the coefficients is in its second state for the conversion-result data piece D. Therefore, the signal level of the original data piece “d” is multiplied by “0” and the signal level of the original data piece “c” is directly used as the signal level of the conversion-result data piece D. Thus, the conversion-result pixel D is assigned the signal level of the original pixel “c” at a time position before the time position of the conversion-result pixel D. Similarly, the property signal 13a is in its high-level state and a combination of the coefficients is in its second state for the conversion-result data piece E. Therefore, the signal level of the original data piece “f” is multiplied by “0” and the signal level of the original data piece “d” is directly used as the signal level of the conversion-result data piece E. Thus, the conversion-result pixel E is assigned the signal level of the original pixel “d” at a time position before the time position of the conversion-result pixel E. The property signal 13a is in its high-level state and a combination of the coefficients is in its first state for the conversion-result data piece H. Therefore, the signal level of the original data piece “g” is multiplied by “0” and the signal level of the original data piece “h” is directly used as the signal level of the conversion-result data piece H. Thus, the conversion-result pixel H is assigned the signal level of the original pixel “h” at a time position after the time position of the conversion-result pixel H. Similarly, the property signal 13a is in its high-level state and a combination of the coefficients is in its first state for the conversion-result data piece I. Therefore, the signal level of the original data piece “h” is multiplied by “0” and the signal level of the next data piece is directly used as the signal level of the conversion-result data piece I. Thus, the conversion-result pixel I is assigned the signal level of the original pixel at a time position after the time position of the conversion-result pixel I.

With reference to the portions (d), (e), and (f) of FIG. 10, there is a time region (a non-interpolation region) RT of twice the inter-pixel interval during which the property signal 13a is in its high-level state so that linear interpolation is non-implemented. The non-interpolation region RT is centered at a time point corresponding to an original pixel (an original data piece) at which the waveform monitor circuit 13 concludes that the signal level represented by the input digital signal 101 is discontinuously changing. The non-interpolation region RT consists of a front edge region RSF, a central region RC, and a rear edge region RSR. The front edge region RSF precedes the central region RC. The rear edge region RSR follows the central region RC. The central region RC contains a time point corresponding to the original pixel at which the waveform monitor circuit 13 concludes that the signal level represented by the input digital signal 101 is discontinuously changing. When a time point corresponding to a conversion-result pixel (a conversion-result data piece) in question exists in the central region RC, the signal level of the original pixel at which the signal level represented by the input digital signal 101 is concluded to be discontinuously changing is used as the signal level of the conversion-result pixel in question. When a time point corresponding to a conversion-result pixel (a conversion-result data piece) in question exists in the front edge region RSF, the signal level of an original pixel at a time point in the front edge region RSF is used as the signal level of the conversion-result pixel in question. When a time point corresponding to a conversion-result pixel (a conversion-result data piece) in question exists in the rear edge region RSR, the signal level of an original pixel at a time point in the rear edge region RSR is used as the signal level of the conversion-result pixel in question.

As shown in the portion (d) of FIG. 10, the isolated point “h” in the original picture is changed into a single high-level pixel represented by the conversion-result data piece H and forming an isolated point also. Accordingly, an irregularity in luminance can be prevented from occurring in the conversion-result picture. It is preferable that the width of the central region RC depends on the designated magnification indicated by the parameter signal CR. This design prevents the occurrence of a luminance irregularity even when the designated magnification is changed.

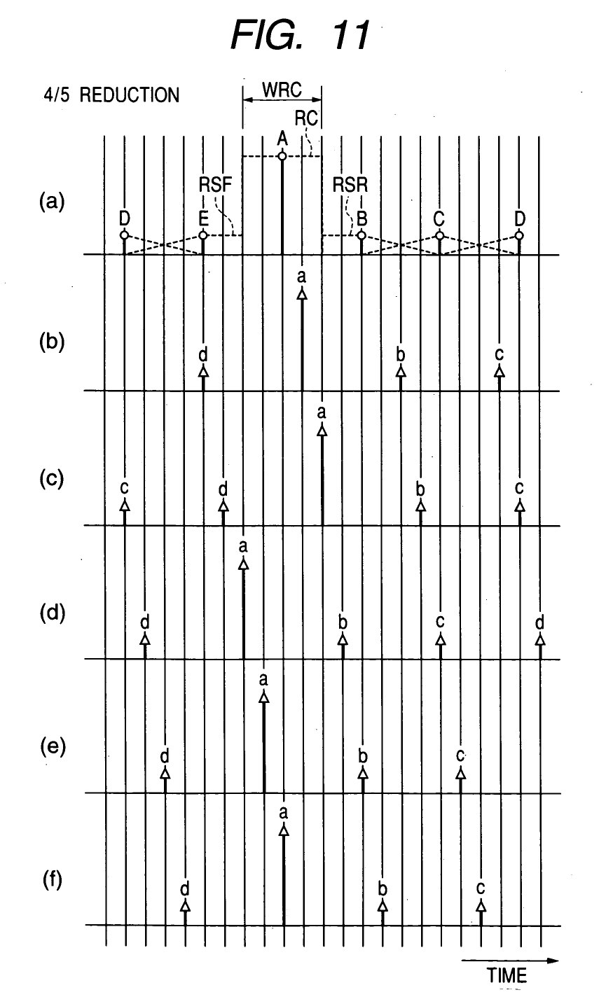

FIG. 11 has a portion (a) showing an example of a sequence of pixel-corresponding data pieces D, E, A, B, C, and D of the input digital signal 101. In FIG. 11, the vertical parallel lines denote reference timings of a clock period (the period of a clock signal used in image processing) or reference timings of an integral multiple of the clock period. The pixels represented by the original data pieces D, E, A, B, C, and D are located at respective time positions equal to ones selected from these reference timings. The interval between two neighboring reference timings (two vertical parallel lines) in FIG. 11 is referred to as the clock width. The original data piece A represents a high-level pixel corresponding to an isolated point in an original picture. Accordingly, there is a central region RC centered at the time position of the original pixel (the original data piece) A. In addition, there are a front edge region RSF and a rear edge region RSR preceding and following the central region RC respectively. During the central region RC, the front edge region RSF, and the rear edge region RSR, linear interpolation is non-implemented. On the other hand, during other time regions, linear interpolation is implemented. In the portion (a) of FIG. 11, the crossing broken lines denote the linear-interpolation-implemented time regions.

In the portion (a) of FIG. 11, the time interval between two neighboring original pixels is equal to 4 times the clock width. Preferably, the width WRC of the central region RC is equal to or slightly greater than 4 times the clock width. The width of the front edge region RSF is equal to or slightly smaller than twice the clock width. The width of the rear edge region RSR is equal to or slightly smaller than twice the clock width. In this case, it is possible to prevent an isolated point in an original picture from being omitted from a conversion-result picture.

The resolution conversion circuit 14 implements interpolation with an interpolation phase which can be changed among different values including first to fifth values. The apparatus of FIG. 4 which is operating in the 4/5 picture reduction mode changes the sequence of the original data pieces D, E, A, B, C, and D in the portion (a) of FIG. 11 into a sequence of pixel-corresponding data pieces “d”, “a”, “b”, and “c” of the conversion-result digital signal (the output digital signal) 301.

When the interpolation phase is equal to the first value, the conversion-result pixels (the conversion-result data pieces) “d”, “a”, “b”, and “c” are located at time positions as shown in a portion (b) of FIG. 11. In this case, the conversion-result data piece “d” is assigned the signal level of the original data piece E. The conversion-result data piece “a” is assigned the signal level of the original data piece A. The signal level of the conversion-result data piece “b” is decided by linear interpolation responsive to the signal levels of the original data pieces B and C. The signal level of the conversion-result data piece “c” is decided by linear interpolation responsive to the signal levels of the original data pieces C and D.

When the interpolation phase is equal to the second value, the conversion-result pixels (the conversion-result data pieces) “d”, “a”, “b”, and “c” are located at time positions as shown in a portion (c) of FIG. 11. In this case, the conversion-result data piece “d” is assigned the signal level of the original data piece E. The conversion-result data piece “a” is assigned the signal level of the original data piece A. The signal level of the conversion-result data piece “b” is decided by linear interpolation responsive to the signal levels of the original data pieces B and C. The conversion-result data piece “c” is assigned the signal level of the original data piece D.

When the interpolation phase is equal to the third value, the conversion-result pixels (the conversion-result data pieces) “d”, “a”, “b”, and “c” are located at time positions as shown in a portion (d) of FIG. 11. In this case, the signal level of the conversion-result data piece “d” is decided by linear interpolation responsive to the signal levels of the original data pieces D and E. The conversion-result data piece “a” is assigned the signal level of the original data piece A. The conversion-result data piece “b” is assigned the signal level of the original data piece B. The conversion-result data piece “c” is assigned the signal level of the original data piece C.

When the interpolation phase is equal to the fourth value, the conversion-result pixels (the conversion-result data pieces) “d”, “a”, “b”, and “c” are located at time positions as shown in a portion (e) of FIG. 11. In this case, the signal level of the conversion-result data piece “d” is decided by linear interpolation responsive to the signal levels of the original data pieces D and E. The conversion-result data piece “a” is assigned the signal level of the original data piece A. The conversion-result data piece “b” is assigned the signal level of the original data piece B. The signal level of the conversion-result data piece “c” is decided by linear interpolation responsive to the signal levels of the original data pieces C and D.

When the interpolation phase is equal to the fifth value, the conversion-result pixels (the conversion-result data pieces) “d”, “a”, “b”, and “c” are located at time positions as shown in a portion (f) of FIG. 11. In this case, the signal level of the conversion-result data piece “d” is decided by linear interpolation responsive to the signal levels of the original data pieces D and E. The conversion-result data piece “a” is assigned the signal level of the original data piece A. The signal level of the conversion-result data piece “b” is decided by linear interpolation responsive to the signal levels of the original data pieces B and C. The signal level of the conversion-result data piece “c” is decided by linear interpolation responsive to the signal levels of the original data pieces C and D.

As shown in FIG. 11, the isolated point represented by the original data piece A is prevented from being omitted from the conversion-result picture when the interpolation phase is equal to any one of the first to fifth values. In the case where the conversion-result data piece “a” is located at a time point on the boundary between the front edge region RSF and the central region RC or the boundary between the central region RC and the rear edge region RSR, the conversion-result data piece is assigned the signal level of the original data piece A at a time point contained in the central region RC (see the portions (c) and (d) of FIG. 11).

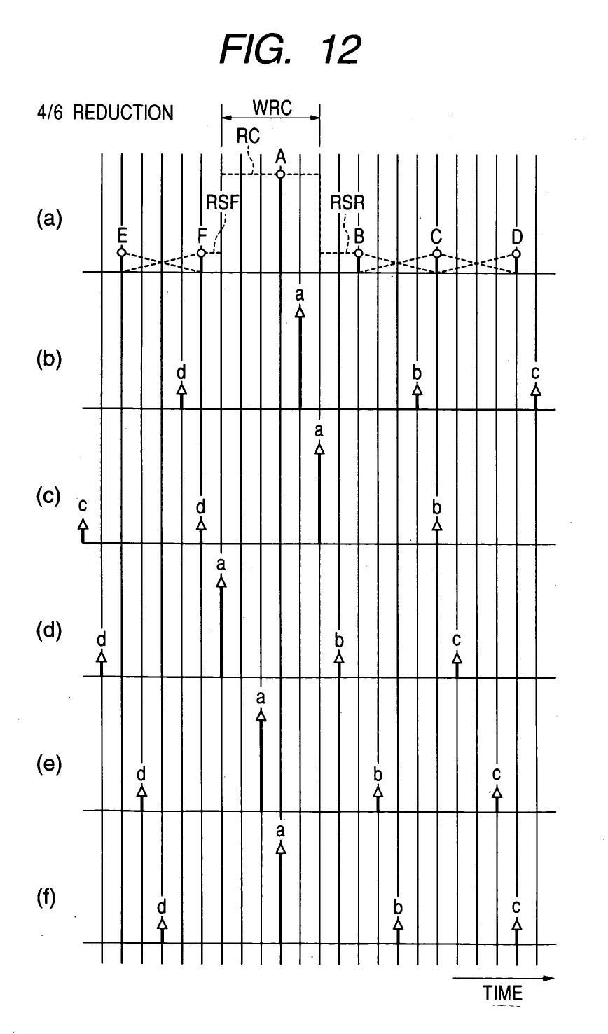

FIG. 12 has a portion (a) showing an example of a sequence of pixel-corresponding data pieces E, F, A, B, C, and D of the input digital signal 101. The vertical parallel lines in FIG. 12 are similar in meaning to those in FIG. 11. The pixels represented by the original data pieces E, F, A, B, C, and D are located at respective time positions equal to ones selected from reference timings. The original data piece A represents a high-level pixel corresponding to an isolated point in an original picture. Accordingly, there is a central region RC covering a time point of the original pixel (the original data piece) A. In addition, there are a front edge region RSF and a rear edge region RSR preceding and following the central region RC respectively. The crossing broken lines in the portion (a) of FIG. 12 are similar in meaning to those in the portion (a) of FIG. 11.

In the portion (a) of FIG. 12, the time interval between two neighboring original pixels is equal to 4 times the clock width. Preferably, the width WRC of the central region RC is equal to or slightly greater than 5 times the clock width. The width of the front edge region RSF is equal to or slightly smaller than the clock width. The width of the rear edge region RSR is equal to or slightly smaller than twice the clock width. In this case, it is possible to prevent an isolated point in an original picture from being omitted from a conversion-result picture.

The resolution conversion circuit 14 implements interpolation with an interpolation phase which can be changed among different values including first to fifth values. The apparatus of FIG. 4 which is operating in a 4/6 picture reduction mode changes the sequence of the original data pieces E, F, A, B, C, and D in the portion (a) of FIG. 12 into a sequence of pixel-corresponding data pieces “d”, “a”, “b”, and “c” of the conversion-result digital signal (the output digital signal) 301.

When the interpolation phase is equal to the first value, the conversion-result pixels (the conversion-result data pieces) “d”, “a”, “b”, and “c” are located at time positions as shown in a portion (b) of FIG. 12. In this case, the signal level of the conversion-result data piece “d” is decided by linear interpolation responsive to the signal levels of the original data pieces E and F. The conversion-result data piece “a” is assigned the signal level of the original data piece A. The signal level of the conversion-result data piece “b” is decided by linear interpolation responsive to the signal levels of the original data pieces B and C. The signal level of the conversion-result data piece “c” is decided by linear interpolation responsive to the signal levels of the original data piece D and the next original data piece E.

When the interpolation phase is equal to the second value, the conversion-result pixels (the conversion-result data pieces) “d”, “a”, “b”, and “c” are located at time positions as shown in a portion (c) of FIG. 12. In this case, the conversion-result data piece “d” is assigned the signal level of the original data piece F. The conversion-result data piece “a” is assigned the signal level of the original data piece A. The conversion-result data piece “b” is assigned the signal level of the original data piece C. The signal level of the conversion-result data piece “c” is decided by linear interpolation responsive to the signal levels of the original data pieces D and E.

When the interpolation phase is equal to the third value, the conversion-result pixels (the conversion-result data pieces) “d”, “a”, “b”, and “c” are located at time positions as shown in a portion (d) of FIG. 12. In this case, the signal level of the conversion-result data piece “d” is decided by linear interpolation responsive to the signal levels of the original data pieces D and E. The conversion-result data piece “a” is assigned the signal level of the original data piece A. The conversion-result data piece “b” is assigned the signal level of the original data piece B. The signal level of the conversion-result data piece “c” is decided by linear interpolation responsive to the signal levels of the original data pieces C and D.

When the interpolation phase is equal to the fourth value, the conversion-result pixels (the conversion-result data pieces) “d”, “a”, “b”, and “c” are located at time positions as shown in a portion (e) of FIG. 12. In this case, the signal level of the conversion-result data piece “d” is decided by linear interpolation responsive to the signal levels of the original data pieces E and F. The conversion-result data piece “a” is assigned the signal level of the original data piece A. The signal level of the conversion-result data piece “b” is decided by linear interpolation responsive to the signal levels of the original data pieces B and C. The signal level of the conversion-result data piece “c” is decided by linear interpolation responsive to the signal levels of the original data pieces C and D.

When the interpolation phase is equal to the fifth value, the conversion-result pixels (the conversion-result data pieces) “d”, “a”, “b”, and “c” are located at time positions as shown in a portion (f) of FIG. 12. In this case, the signal level of the conversion-result data piece “d” is decided by linear interpolation responsive to the signal levels of the original data pieces E and F. The conversion-result data piece “a” is assigned the signal level of the original data piece A. The signal level of the conversion-result data piece “b” is decided by linear interpolation responsive to the signal levels of the original data pieces B and C. The conversion-result data piece “c” is assigned the signal level of the original data piece D.

As shown in FIG. 12, the isolated point represented by the original data piece A is prevented from being omitted from the conversion-result picture when the interpolation phase is equal to any one of the first to fifth values. There is another interpolation phase value between the third value (the portion (d) of FIG. 12) and the fourth value (the portion (e) of FIG. 12). Also, at this interpolation phase value, the isolated point represented by the original data piece A is prevented from being omitted from the conversion-result picture.

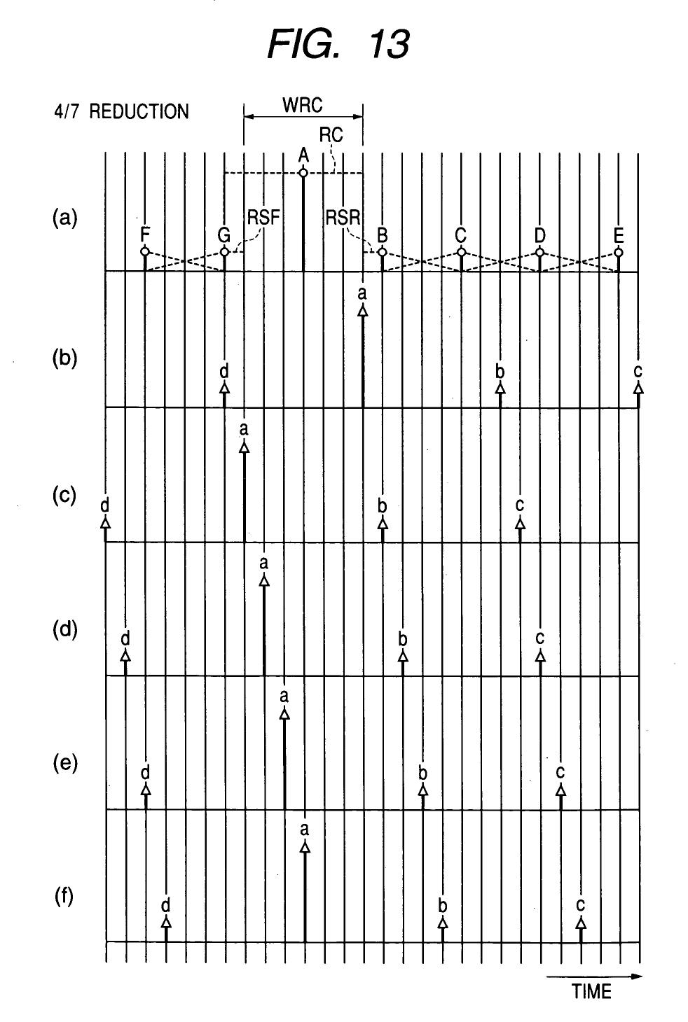

FIG. 13 has a portion (a) showing an example of a sequence of pixel-corresponding data pieces F, G, A, B, C, D, and E of the input digital signal 101. The vertical parallel lines in FIG. 13 are similar in meaning to those in FIG. 11. The pixels represented by the original data pieces F, G, A, B, C, D, and E are located at respective time positions equal to ones selected from reference timings. The original data piece A represents a high-level pixel corresponding to an isolated point in an original picture. Accordingly, there is a central region RC covering a time point of the original pixel (the original data piece) A. In addition, there are a front edge region RSF and a rear edge region RSR preceding and following the central region RC respectively. The crossing broken lines in the portion (a) of FIG. 13 are similar in meaning to those in the portion (a) of FIG. 11.

In the portion (a) of FIG. 13, the time interval between two neighboring original pixels is equal to 4 times the clock width. Preferably, the width WRC of the central region RC is equal to or slightly greater than 6 times the clock width. The width of the front edge region RSF is equal to or slightly smaller than the clock width. The width of the rear edge region RSR is equal to or slightly smaller than the clock width. In this case, it is possible to prevent an isolated point in an original picture from being omitted from a conversion-result picture.

The resolution conversion circuit 14 implements interpolation with an interpolation phase which can be changed among different values including first to fifth values. The apparatus of FIG. 4 which is operating in a 4/7 picture reduction mode changes the sequence of the original data pieces F, G, A, B, C, D, and E in the portion (a) of FIG. 13 into a sequence of pixel-corresponding data pieces “d”, “a”, “b”, and “c” of the conversion-result digital signal (the output digital signal) 301.

When the interpolation phase is equal to the first value, the conversion-result pixels (the conversion-result data pieces) “d”, “a”, “b”, and “c” are located at time positions as shown in a portion (b) of FIG. 13. In this case, the conversion-result data piece “d” is assigned the signal level of the original data piece G. The conversion-result data piece “a” is assigned the signal level of the original data piece A. The signal level of the conversion-result data piece “b” is decided by linear interpolation responsive to the signal levels of the original data pieces C and D. The signal level of the conversion-result data piece “c” is decided by linear interpolation responsive to the signal levels of the original data pieces E and F.

When the interpolation phase is equal to the second value, the conversion-result pixels (the conversion-result data pieces) “d”, “a”, “b”, and “c” are located at time positions as shown in a portion (c) of FIG. 13. In this case, the signal level of the conversion-result data piece “d” is decided by linear interpolation responsive to the signal levels of the original data pieces E and F. The conversion-result data piece “a” is assigned the signal level of the original data piece A. The conversion-result data piece “b” is assigned the signal level of the original data piece B. The signal level of the conversion-result data piece “c” is decided by linear interpolation responsive to the signal levels of the original data pieces C and D.

When the interpolation phase is equal to the third value, the conversion-result pixels (the conversion-result data pieces) “d”, “a”, “b”, and “c” are located at time positions as shown in a portion (d) of FIG. 13. In this case, the signal level of the conversion-result data piece “d” is decided by linear interpolation responsive to the signal levels of the original data pieces E and F. The conversion-result data piece “a” is assigned the signal level of the original data piece A. The signal level of the conversion-result data piece “b” is decided by linear interpolation responsive to the signal levels of the original data pieces B and C. The conversion-result data piece “c” is assigned the signal level of the original data piece D.

When the interpolation phase is equal to the fourth value, the conversion-result pixels (the conversion-result data pieces) “d”, “a”, “b”, and “c” are located at time positions as shown in a portion (e) of FIG. 13. In this case, the conversion-result data piece “d” is assigned the signal level of the original data piece F. The conversion-result data piece “a” is assigned the signal level of the original data piece A. The signal level of the conversion-result data piece “b” is decided by linear interpolation responsive to the signal levels of the original data pieces B and C. The signal level of the conversion-result data piece “c” is decided by linear interpolation responsive to the signal levels of the original data pieces D and E.

When the interpolation phase is equal to the fifth value, the conversion-result pixels (the conversion-result data pieces) “d”, “a”, “b”, and “c” are located at time positions as shown in a portion (f) of FIG. 13. In this case, the signal level of the conversion-result data piece “d” is decided by linear interpolation responsive to the signal levels of the original data pieces F and G. The conversion-result data piece “a” is assigned the signal level of the original data piece A. The signal level of the conversion-result data piece “b” is decided by linear interpolation responsive to the signal levels of the original data pieces B and C. The signal level of the conversion-result data piece “c” is decided by linear interpolation responsive to the signal levels of the original data pieces D and E.

As shown in FIG. 13, the isolated point represented by the original data piece A is prevented from being omitted from the conversion-result picture when the interpolation phase is equal to any one of the first to fifth values. There are two other interpolation phase values. The first other interpolation phase value corresponds to that shown in the portion (b) of FIG. 12. The second other interpolation phase value corresponds to that shown in the portion (c) of FIG. 12. Also, at the first and second other interpolation phase values, the isolated point represented by the original data piece A is prevented from being omitted from the conversion-result picture.

In the case where the apparatus of FIG. 4 is operating in one selected from picture reduction modes, it is preferable to increase the width WRC of the central region RC as the designated magnification decreases. This design prevents isolated points in an original picture from being omitted from a conversion-result picture regardless of the designated magnification.

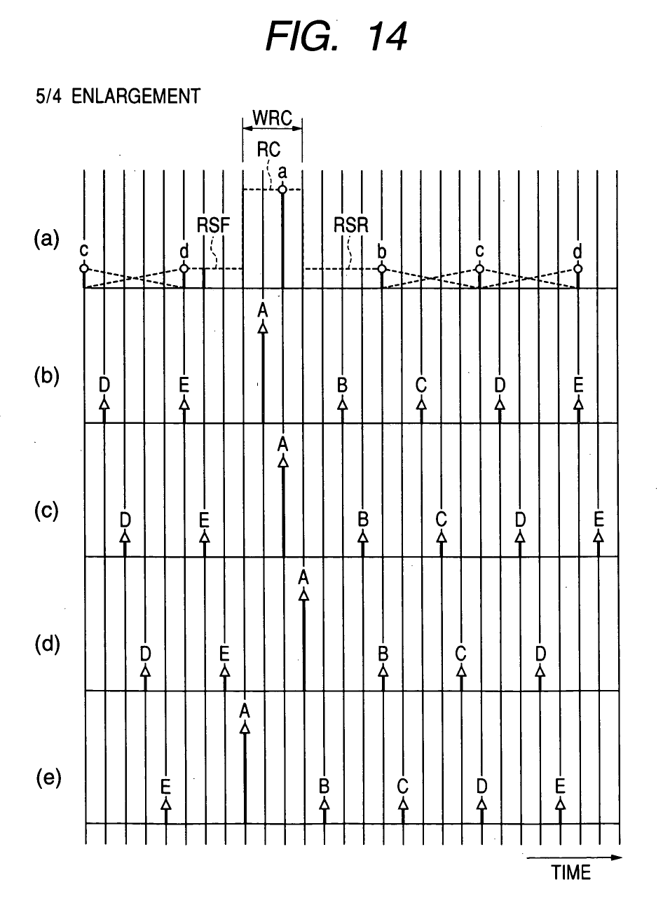

FIG. 14 has a portion (a) showing an example of a sequence of pixel-corresponding data pieces “c”, “d”, “a”, “b”, “c”, and “d” of the input digital signal 101. The vertical parallel lines in FIG. 14 are similar in meaning to those in FIG. 11. The pixels represented by the original data pieces “c”, “d”, “a”, “b”, “c”, and “d” are located at respective time positions equal to ones selected from reference timings. The original data piece “a” represents a high-level pixel corresponding to an isolated point in an original picture. Accordingly, there is a central region RC covering a time point of the original pixel (the original data piece) “a”. In addition, there are a front edge region RSF and a rear edge region RSR preceding and following the central region RC respectively. The crossing broken lines in the portion (a) of FIG. 14 are similar in meaning to those in the portion (a) of FIG. 11.

In the portion (a) of FIG. 14, the time interval between two neighboring original pixels is equal to 5 times the clock width. Preferably, the width WRC of the central region RC is equal to or slightly greater than 3 times the clock width. The width of the front edge region RSF is equal to or slightly smaller than 3 times the clock width. The width of the rear edge region RSR is equal to or slightly smaller than 4 times the clock width. In this case, it is possible to prevent the occurrence of a luminance irregularity related to an isolated point in a conversion-result picture.

The resolution conversion circuit 14 implements interpolation with an interpolation phase which can be changed among different values including first to fourth values. The apparatus of FIG. 4 which is operating in the 5/4 picture enlargement mode changes the sequence of the original data pieces “c”, “d”, “a”, “b”, “c”, and “d” in the portion (a) of FIG. 14 into a sequence of pixel-corresponding data pieces D, E, A, B, C, D, and E of the conversion-result digital signal (the output digital signal) 301.

When the interpolation phase is equal to the first value, the conversion-result pixels (the conversion-result data pieces) D, E, A, B, C, D, and E are located at time positions as shown in a portion (b) of FIG. 14. In this case, the signal level of the conversion-result data piece D is decided by linear interpolation responsive to the signal levels of the original data pieces “c” and “d”. The conversion-result data piece E is assigned the signal level of the original data piece “d”. The conversion-result data piece A is assigned the signal level of the original data piece “a”. The conversion-result data piece B is assigned the signal level of the original data piece “b”. The signal level of the conversion-result data piece C is decided by linear interpolation responsive to the signal levels of the original data pieces “b” and “c”.

When the interpolation phase is equal to the second value, the conversion-result pixels (the conversion-result data pieces) D, E, A, B, C, D, and E are located at time positions as shown in a portion (c) of FIG. 14. In this case, the signal level of the conversion-result data piece D is decided by linear interpolation responsive to the signal levels of the original data pieces “c” and “d”. The conversion-result data piece E is assigned the signal level of the original data piece “d”. The conversion-result data piece A is assigned the signal level of the original data piece “a”. The conversion-result data piece B is assigned the signal level of the original data piece “b”. The signal level of the conversion-result data piece C is decided by linear interpolation responsive to the signal levels of the original data pieces “b” and “c”.

When the interpolation phase is equal to the third value, the conversion-result pixels (the conversion-result data pieces) D, E, A, B, C, and D are located at time positions as shown in a portion (d) of FIG. 14. In this case, the signal level of the conversion-result data piece D is decided by linear interpolation responsive to the signal levels of the original data pieces “c” and “d”. The conversion-result data piece E is assigned the signal level of the original data piece “d”. The conversion-result data piece A is assigned the signal level of the original data piece “a”. The conversion-result data piece B is assigned the signal level of the original data piece “b”. The signal level of the conversion-result data piece C is decided by linear interpolation responsive to the signal levels of the original data pieces “b” and “c”.

When the interpolation phase is equal to the fourth value, the conversion-result pixels (the conversion-result data pieces) E, A, B, C, D, and E are located at time positions as shown in a portion (e) of FIG. 14. In this case, the signal level of the conversion-result data piece E is decided by linear interpolation responsive to the signal levels of the original data pieces “c” and “d”. The conversion-result data piece A is assigned the signal level of the original data piece “a”. The conversion-result data piece B is assigned the signal level of the original data piece “b”. The signal level of the conversion-result data piece C is decided by linear interpolation responsive to the signal levels of the original data pieces “b” and “c”. The conversion-result data piece D is assigned the signal level of the original data piece “c”.

As shown in FIG. 14, the isolated point represented by the original data piece “a” is correctly converted into an isolated point in the conversion-result picture when the interpolation phase is equal to any one of the first to fourth values. Therefore, it is possible to prevent a luminance irregularity from occurring in the conversion-result picture.

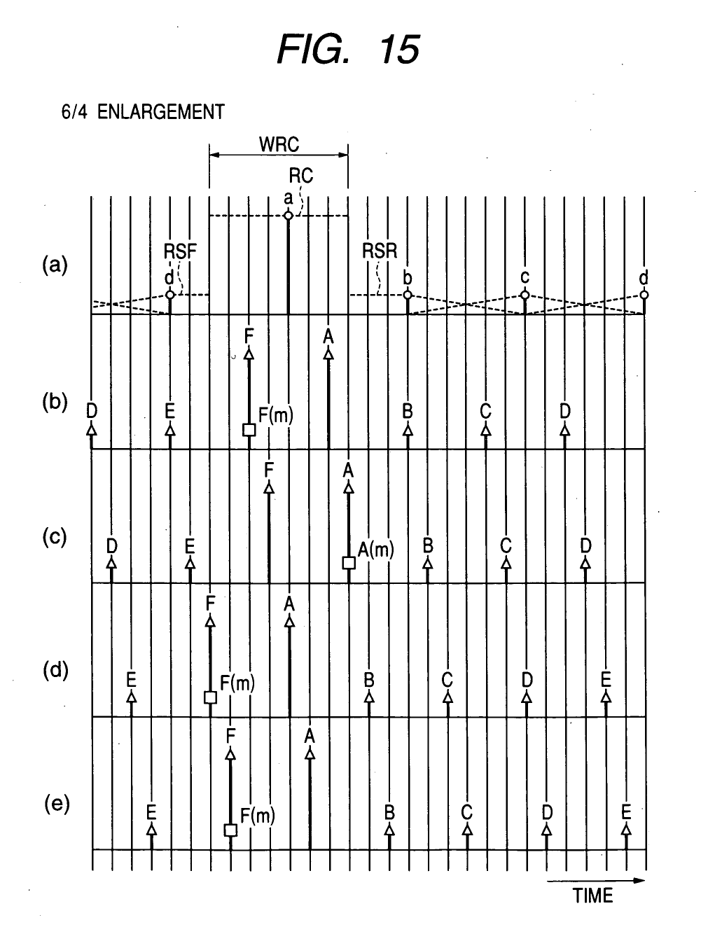

FIG. 15 has a portion (a) showing an example of a sequence of pixel-corresponding data pieces “d”, “a”, “b”, “c”, and “d” of the input digital signal 101. The vertical parallel lines in FIG. 15 are similar in meaning to those in FIG. 11. The pixels represented by the original data pieces “d”, “a”, “b”, “c”, and “d” are located at respective time positions equal to ones selected from reference timings. The original data piece “a” represents a high-level pixel corresponding to an isolated point in an original picture. Accordingly, there is a central region RC covering a time point of the original pixel (the original data piece) “a”. In addition, there are a front edge region RSF and a rear edge region RSR preceding and following the central region RC respectively. The crossing broken lines in the portion (a) of FIG. 15 are similar in meaning to those in the portion (a) of FIG. 11.

In the portion (a) of FIG. 15, the time interval between two neighboring original pixels is equal to 6 times the clock width. Preferably, the width WRC of the central region RC is equal to or slightly greater than 7 times the clock width. The width of the front edge region RSF is equal to or slightly smaller than twice the clock width. The width of the rear edge region RSR is equal to or slightly smaller than 3 times the clock width. In this case, it is possible to prevent the occurrence of a luminance irregularity related to an isolated point in a conversion-result picture.

The resolution conversion circuit 14 implements interpolation with an interpolation phase which can be changed among different values including first to fourth values. The apparatus of FIG. 4 which is operating in a 6/4 picture enlargement mode changes the sequence of the original data pieces “d”, “a”, “b”, “c”, and “d” in the portion (a) of FIG. 15 into a sequence of pixel-corresponding data pieces D, E, F, A, B, C, and D of the conversion-result digital signal (the output digital signal) 301.

When the interpolation phase is equal to the first value, the conversion-result pixels (the conversion-result data pieces) D, E, F, A, B, C, and D are located at time positions as shown in a portion (b) of FIG. 15. In this case, the conversion-result data piece E is assigned the signal level of the original data piece “d”. The conversion-result data piece F is assigned the signal level of the original data piece “a”. The conversion-result data piece A is assigned the signal level of the original data piece “a”. The conversion-result data piece B is assigned the signal level of the original data piece “b”. The signal level of the conversion-result data piece C is decided by linear interpolation responsive to the signal levels of the original data pieces “b” and “c”. The signal level of the conversion-result data piece D is decided by linear interpolation responsive to the signal levels of the original data pieces “c” and “d”.

When the interpolation phase is equal to the second value, the conversion-result pixels (the conversion-result data pieces) D, E, F, A, B, C, and D are located at time positions as shown in a portion (c) of FIG. 15. In this case, the conversion-result data piece E is assigned the signal level of the original data piece “d”. The conversion-result data piece F is assigned the signal level of the original data piece “a”. The conversion-result data piece A is assigned the signal level of the original data piece “a”. The signal level of the conversion-result data piece B is decided by linear interpolation responsive to the signal levels of the original data pieces “b” and “c”. The signal level of the conversion-result data piece C is decided by linear interpolation responsive to the signal levels of the original data pieces “b” and “c”. The signal level of the conversion-result data piece D is decided by linear interpolation responsive to the signal levels of the original data pieces “c” and “d”.

When the interpolation phase is equal to the third value, the conversion-result pixels (the conversion-result data pieces) E, F, A, B, C, D, and E are located at time positions as shown in a portion (d) of FIG. 15. In this case, the signal level of the conversion-result data piece E is decided by linear interpolation responsive to the signal levels of the original data pieces “c” and “d”. The conversion-result data piece F is assigned the signal level of the original data piece “a”. The conversion-result data piece A is assigned the signal level of the original data piece “a”. The conversion-result data piece B is assigned the signal level of the original data piece “b”. The signal level of the conversion-result data piece C is decided by linear interpolation responsive to the signal levels of the original data pieces “b” and “c”. The conversion-result data piece D is assigned the signal level of the original data piece “c”

When the interpolation phase is equal to the fourth value, the conversion-result pixels (the conversion-result data pieces) E, F, A, B, C, D, and E are located at time positions as shown in a portion (e) of FIG. 15. In this case, the signal level of the conversion-result data piece E is decided by linear interpolation responsive to the signal levels of the original data pieces “c” and “d”. The conversion-result data piece F is assigned the signal level of the original data piece “a”. The conversion-result data piece A is assigned the signal level of the original data piece “a”. The conversion-result data piece B is assigned the signal level of the original data piece “b”. The signal level of the conversion-result data piece C is decided by linear interpolation responsive to the signal levels of the original data pieces “b” and “c”. The signal level of the conversion-result data piece D is decided by linear interpolation responsive to the signal levels of the original data pieces “c” and “d”.

As shown in FIG. 15, the isolated point represented by the original data piece “a” is converted into two successive high-level pixels (F and A) in the conversion-result picture when the interpolation phase is equal to any one of the first to fourth values. Therefore, it is possible to prevent a luminance irregularity from occurring in the conversion-result picture.

In the portions (b), (d), and (e) of FIG. 15, the conversion-result data piece F may be assigned the signal level of the original data piece “d”. In this case, the conversion-result data piece F represents a signal level denoted by F(m). In the portion (c) of FIG. 15, the conversion-result data piece A may be assigned the signal level of the original data piece “b”. In this case, the conversion-result data piece A represents a signal level denoted by A(m). According to these modified designs, only a single high-level pixel is allowed to exist in the central region RC and the isolated point represented by the original data piece “a” is correctly converted into an isolated point in the conversion-result picture when the interpolation phase is equal to any one of the first to fourth values. In the modified designs, the resolution conversion circuit 14 responds to a selection signal which is generated in response to user's request, and which decides whether an isolated point (an isolated high-level pixel) in an original picture is converted into two successive high-level pixels or an isolated point in a conversion-result picture.

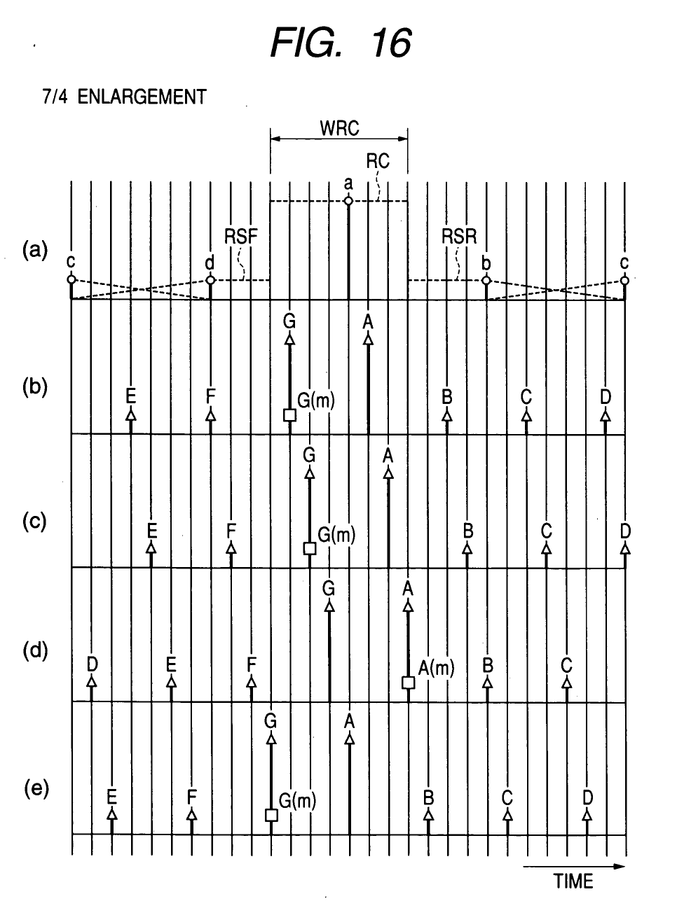

FIG. 16 has a portion (a) showing an example of a sequence of pixel-corresponding data pieces “c”, “d”, “a”, “b”, and “c” of the input digital signal 101. The vertical parallel lines in FIG. 16 are similar in meaning to those in FIG. 11. The pixels represented by the original data pieces “c”, “d”, “a”, “b”, and “c” are located at respective time positions equal to ones selected from reference timings. The original data piece “a” represents a high-level pixel corresponding to an isolated point in an original picture. Accordingly, there is a central region RC covering a time point of the original pixel (the original data piece) “a”. In addition, there are a front edge region RSF and a rear edge region RSR preceding and following the central region RC respectively. The crossing broken lines in the portion (a) of FIG. 16 are similar in meaning to those in the portion (a) of FIG. 11.

In the portion (a) of FIG. 16, the time interval between two neighboring original pixels is equal to 7 times the clock width. Preferably, the width WRC of the central region RC is equal to or slightly greater than 7 times the clock width. The width of the front edge region RSF is equal to or slightly smaller than 3 times the clock width. The width of the rear edge region RSR is equal to or slightly smaller than 4 times the clock width. In this case, it is possible to prevent the occurrence of a luminance irregularity related to an isolated point in a conversion-result picture.

The resolution conversion circuit 14 implements interpolation with an interpolation phase which can be changed among different values including first to fourth values. The apparatus of FIG. 4 which is operating in a 7/4 picture enlargement mode changes the sequence of the original data pieces “c”, “d”, “a”, “b”, and “c” in the portion (a) of FIG. 16 into a sequence of pixel-corresponding data pieces E, F, G, A, B, C, and D of the conversion-result digital signal (the output digital signal) 301.

When the interpolation phase is equal to the first value, the conversion-result pixels (the conversion-result data pieces) E, F, G, A, B, C, and D are located at time positions as shown in a portion (b) of FIG. 16. In this case, the signal level of the conversion-result data piece E is decided by linear interpolation responsive to the signal levels of the original data pieces “c” and “d”. The conversion-result data piece F is assigned the signal level of the original data piece “d”. The conversion-result data piece G is assigned the signal level of the original data piece “a”. The conversion-result data piece A is assigned the signal level of the original data piece “a”. The conversion-result data piece B is assigned the signal level of the original data piece “b”. The signal level of the conversion-result data piece C is decided by linear interpolation responsive to the signal levels of the original data pieces “b” and “c”. The signal level of the conversion-result data piece D is decided by linear interpolation responsive to the signal levels of the original data pieces “b” and “c”.

When the interpolation phase is equal to the second value, the conversion-result pixels (the conversion-result data pieces) E, F, G, A, B, C, and D are located at time positions as shown in a portion (c) of FIG. 16. In this case, the signal level of the conversion-result data piece E is decided by linear interpolation responsive to the signal levels of the original data pieces “c” and “d”. The conversion-result data piece F is assigned the signal level of the original data piece “d”. The conversion-result data piece G is assigned the signal level of the original data piece “a”. The conversion-result data piece A is assigned the signal level of the original data piece “a”. The conversion-result data piece B is assigned the signal level of the original data piece “b”. The signal level of the conversion-result data piece C is decided by linear interpolation responsive to the signal levels of the original data pieces “b” and “c”. The conversion-result data piece D is assigned the signal level of the original data piece “c”.

When the interpolation phase is equal to the third value, the conversion-result pixels (the conversion-result data pieces) D, E, F, G, A, B, and C are located at time positions as shown in a portion (d) of FIG. 16. In this case, the signal level of the conversion-result data piece D is decided by linear interpolation responsive to the signal levels of the original data pieces “c” and “d”. The signal level of the conversion-result data piece E is decided by linear interpolation responsive to the signal levels of the original data pieces “c” and “d”. The conversion-result data piece F is assigned the signal level of the original data piece “d”. The conversion-result data piece G is assigned the signal level of the original data piece “a”. The conversion-result data piece A is assigned the signal level of the original data piece “a”. The conversion-result data piece B is assigned the signal level of the original data piece “b”. The signal level of the conversion-result data piece C is decided by linear interpolation responsive to the signal levels of the original data pieces “b” and “c”.

When the interpolation phase is equal to the fourth value, the conversion-result pixels (the conversion-result data pieces) E, F, G, A, B, C, and D are located at time positions as shown in a portion (e) of FIG. 16. In this case, the signal level of the conversion-result data piece E is decided by linear interpolation responsive to the signal levels of the original data pieces “c” and “d”. The signal level of the conversion-result data piece F is decided by linear interpolation responsive to the signal levels of the original data pieces “c” and “d”. The conversion-result data piece G is assigned the signal level of the original data piece “a”. The conversion-result data piece A is assigned the signal level of the original data piece “a”. The conversion-result data piece B is assigned the signal level of the original data piece “b”. The signal level of the conversion-result data piece C is decided by linear interpolation responsive to the signal levels of the original data pieces “b” and “c”. The signal level of the conversion-result data piece D is decided by linear interpolation responsive to the signal levels of the original data pieces “b” and “c”.

As shown in FIG. 16, the isolated point represented by the original data piece “a” is converted into two successive high-level pixels (G and A) in the conversion-result picture when the interpolation phase is equal to any one of the first to fourth values. Therefore, it is possible to prevent a luminance irregularity from occurring in the conversion-result picture.

In the portions (b), (c), and (e) of FIG. 16, the conversion-result data piece G may be assigned the signal level of the original data piece “d”. In this case, the conversion-result data piece G represents a signal level denoted by G(m). In the portion (d) of FIG. 16, the conversion-result data piece A may be assigned the signal level of the original data piece “b”. In this case, the conversion-result data piece A represents a signal level denoted by A(m). According to these modified designs, only a single high-level pixel is allowed to exist in the central region RC and the isolated point represented by the original data piece “a” is correctly converted into an isolated point in the conversion-result picture when the interpolation phase is equal to any one of the first to fourth values. In the modified designs, the resolution conversion circuit 14 responds to a selection signal which is generated in response to user's request, and which decides whether an isolated point (an isolated high-level pixel) in an original picture is converted into two successive high-level pixels or an isolated point in a conversion-result picture.

In the case where the designated magnification corresponds to a picture reduction or enlargement factor of N/M, it is preferable to set the width WRC of the central region RC according to an equation as follows.

WRC=DPXL·(K·M−1)/N+α (1)

where DPXL denotes the inter-pixel interval expressed in unit of clock width; K denotes an integer; and “α” denotes a predetermined constant equal to or greater than “0” and less than the clock width. The integer K is equal to “1” for picture reducing conversion, and is equal to the natural number to which the magnification factor N/M is rounded for picture enlarging conversion.

In the case of picture reducing conversion, the equation (1) increases the width WRC of the central region RC as the magnification factor N/M decreases, that is, as the number M increases or the number N decreases. Also in the case of picture enlarging conversion with a magnification factor N/M less than 1.5, the integer K is equal to “1” and hence the equation (1) increases the width WRC of the central region RC as the magnification factor N/M decreases, that is, as the number M increases or the number N decreases.

In the case of picture enlarging conversion with a magnification factor N/M equal to or less than 2.0, it is preferable to increase the width WRC of the central region RC as the magnification factor N/M increases.

The equation (1) uses the clock width as a reference. The clock width is equal to the period of image processing. For picture reducing conversion with a magnification factor of 4/6, the image processing period (the reference period) is equal to one fourth of the inter-pixel interval DPXL. For picture reducing conversion with a magnification factor of 2/3, the image processing period (the reference period) is equal to a half of the inter-pixel interval DPXL. The difference in reference period between picture reducing conversion with a magnification factor of 4/6 and picture reducing conversion with a magnification factor of 2/3 causes a difference in width WRC therebetween. Specifically, for picture reducing conversion with a magnification factor of 4/6, the equation (1) gives the width WRC of the central region RC as “WRC=DPXL·(5/4)+α”. For picture reducing conversion with a magnification factor of 2/3, the equation (1) gives the width WRC of the central region RC as “WRC=DPXL·(2/2)+α”. A similar relation exists between picture enlarging conversion with a magnification factor of 6/4 and picture enlarging conversion with a magnification factor of 3/2.

What is claimed is:

1. An image data processing apparatus comprising:
first means for monitoring a level of a first digital signal representative of an original picture in a prescribed region having a predetermined number of pixels, and deciding whether or not the monitored level changes discontinuously at a pixel of interest in the prescribed region;
second means for generating first data representative of a linear interpolation coefficient in response to a conversion magnification;
third means for generating second data representative of a non-linear-interpolation coefficient in response to the conversion magnification;
fourth means for selecting the first data generated by the second means as selection-result data when the first means decides that the monitored level does not change discontinuously at the pixel of interest, and selecting the second data generated by the third means as the selection-result data when the first means decides that the monitored level changes discontinuously at the pixel of interest; and
fifth means for subjecting the first digital signal to an interpolation-based filtering process responsive to the selection-result data generated by the fourth means to convert the first digital signal into a second digital signal representative of a conversion-result picture.

2. An image data processing apparatus as recited in claim 1, wherein the third means and the fourth means comprise means for using the level of the first digital signal at the pixel of interest as a level of the second digital signal at a pixel in a setting range containing a time point corresponding to the pixel of interest when the first means decides that the monitored level changes discontinuously at the pixel of interest, and means for increasing the setting range as the conversion magnification decreases.

3. An image data processing apparatus as recited in claim 1, wherein the third means and the fourth means comprise means for using the level of the first digital signal at the pixel of interest as a level of the second digital signal at a pixel in a setting range containing a time point corresponding to the pixel of interest when the first means decides that the monitored level changes discontinuously at the pixel of interest, and means for increasing the setting range as the conversion magnification increases in cases where the conversion magnification corresponds to picture enlarging conversion.

4. An image data processing apparatus comprising:
first means for detecting luminance levels represented by a predetermined number of pieces of a first digital signal representative of an original picture, the pieces of the first digital signal indicating periodically-updated neighboring pixels including a periodically-updated pixel of interest in the original picture;
second means for calculating differences among the luminance levels detected by the first means;
third means for deciding whether or not an absolute value of each of the differences calculated by the second means exceeds a predetermined threshold value;
fourth means for determining whether or not the pixel of interest corresponds to an isolated point in the original picture in response to a result of the deciding by the third means;
fifth means for setting a luminance level represented by a piece in question of a second digital signal representative of a conversion-result picture in accordance with the luminance level represented by the piece of the first digital signal which indicates the pixel of interest without interpolation when the fourth means determines that the pixel of interest corresponds to an isolated point in the original picture, the piece in question of the second digital signal indicating a pixel in the conversion-result picture which corresponds to the pixel of interest in the original picture; and
sixth means for setting the luminance level represented by the piece in question of the second digital signal according to interpolation responsive to luminance levels represented by neighboring pieces of the first digital signal when the fourth means determines that the pixel of interest does not corresponds to an isolated point in the original picture.
